(19) United States
(12) Patent Application Publication
(10) Pub. No.: US 2023/0028086 A1
(43) Pub. Date: Jan. 26, 2023

(54) COLORING COMPOSITION, INK FOR INK JET RECORDING, INK JET RECORDING METHOD, AND INK JET PRINTER CARTRIDGE

(71) Applicant: FUJIFILM Corporation, Tokyo (JP)

(72) Inventors: Keiichi TATEISHI, Ashigarakami-gun (JP); Takashi SAITOU, Ashigarakami-gun (JP); Yuta TAKASAKI, Ashigarakami-gun (JP)

(73) Assignee: FUJIFILM Corporation, Tokyo (JP)

(21) Appl. No.: 17/943,210

(22) Filed: Sep. 13, 2022

Related U.S. Application Data
(63) Continuation of application No. PCT/JP2021/012380, filed on Mar. 24, 2021.

(30) Foreign Application Priority Data
Mar. 31, 2020 (JP) 2020-064283

(51) Int. Cl. C09B 67/22; C09D 11/328; C09D 11/037; B41J 2/21

(52) U.S. Cl. CPC C09B 67/0042; C09D 11/328; C09D 11/037; B41J 2/2107

(57) ABSTRACT

A coloring composition includes: a compound represented by the General Formula (1) as defined herein; and a compound represented by the General Formula (D) as defined herein, in which a mass ratio {General Formula (1)/General Formula (D)} of a content of the compound represented by the General Formula (1) to a content of the compound represented by the General Formula (D) is {99/1} to {50/50}.

### CROSS REFERENCE TO RELATED APPLICATION

This is a continuation of International Application No. PCT/JP2021/012380 filed on Mar. 24, 2021, and claims priority from Japanese Patent Application No. 2020-064283 filed on Mar. 31, 2020, the entire disclosures of which are incorporated herein by reference.

### BACKGROUND OF THE INVENTION

### 1. Field of the Invention

The present invention relates to a coloring composition, an ink for ink jet recording, an ink jet recording method, and an ink jet printer cartridge.

### 2. Description of the Related Art

As commonly known, an ink jet recording method is a method in which printing is performed by causing ink droplets to fly and adhere to a recording medium, such as a paper sheet. This printing method enables a high-definition, high-quality image to be printed with an inexpensive apparatus at a high speed in an easy and simple way. In particular, in the field of color printing, an ink jet recording method is considered as an image forming method that can be an alternative to photography and technical studies thereof has been conducted.

A xanthene compound is known as a dye with which an image having a magenta hue can be formed. An ink for ink jet recording which includes a xanthene compound is described in, for example, JP2013-133395A, WO2015/105108A, and WO2018/062044A.

### SUMMARY OF THE INVENTION

There is room for further improvement of the performance of a coloring composition with which an image having a magenta hue can be formed. In particular, there is a demand for a coloring composition the performance of which is more unlikely to become degraded when the coloring composition is stored over a prolonged period of time than coloring compositions known in the related art (i.e., which is more excellent in terms of long-term storage stability than coloring compositions known in the related art).

An object of the present invention is to provide a coloring composition that enables the formation of an image that has a magenta hue, a high chroma, and a high print density and that is excellent in terms of light resistance, ozone resistance, and moisture resistance, the coloring composition being also excellent in terms of long-term storage stability, an ink for ink jet recording which includes the coloring composition, an ink jet recording method in which the ink for ink jet recording is used, and an ink jet printer cartridge including the ink for ink jet recording.

The inventors of the present invention conducted extensive studies and consequently found that the above object can be achieved by the means described below. Although a compound represented by General Formula (1) (i.e., a xanthene compound) and a compound represented by General Formula (D) (i.e., an azo compound) are used in combination in the present invention, the positions at which the terminal naphthyl groups used in the azo compound used in the present invention are substituted with sulfo groups are different from those of the azo compound described in WO2018/062044A. Although details of the mechanisms are not clear, it is considered that the azo compound used in the present invention has a higher solubility in solvents than the azo compound described in WO2018/062044A due to, for example, the impacts of steric hindrance caused by the sulfo groups introduced to the positions vicinal to the azo groups. It is considered that, therefore, the coloring composition according to the present invention has further excellent long-term storage stability.

Specifically, the present invention is as described below.

[1] A coloring composition including a compound represented by the following General Formula (1); and a compound represented by the following General Formula (D),

in which a mass ratio {General Formula (1)/General Formula (D)} of a content of the compound represented by the General Formula (1) to a content of the compound represented by the General Formula (D) is {99/1} to {50/50},

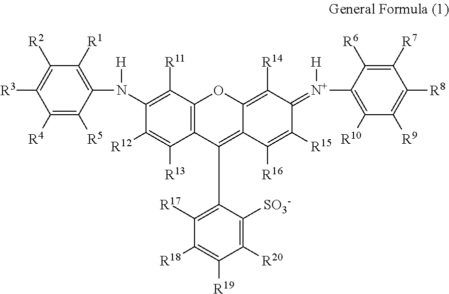

in which, in the General Formula (1), R¹, R⁵, R⁶, and R¹⁰ each independently represent an alkyl group; R⁴, R⁹, R¹¹, R¹², R¹³, R¹⁴, R¹⁵, R¹⁶, R¹⁷, R¹⁸, R¹⁹, and R²⁰ each independently represent a hydrogen atom, an alkyl group, an aryl group, a halogen atom, a carboxyl group, or a sulfo group; R², R³, R⁷, and R⁸ each independently represent a hydrogen atom, an alkyl group, or a substituent represented by the following General Formula (A); and at least one of R², R³, R⁷, or R⁸ represents a substituent represented by the General Formula (A),

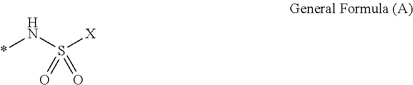

in which, in the General Formula (A), X represents a substituent represented by the following General Formula (X1), (X2), or (X3); and * denotes a direct bond to a benzene ring,

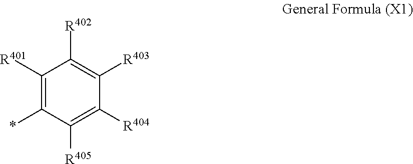

in which, in the General Formula (X1), R⁴⁰¹, R⁴⁰², R⁴⁰³, R⁴⁰⁴, and R⁴⁰⁵ each independently represent a hydrogen atom, an alkyl group, an aryl group, a hydroxyl group, a halogen atom, a nitro group, a trifluoromethyl group, a carboxyl group, or a sulfo group; R⁴⁰¹, R⁴⁰², R⁴⁰³, R⁴⁰⁴, and R⁴⁰⁵ satisfy the following condition (i) or (ii); and * denotes a direct bond to a sulfur atom,

Condition (i): At least one of R⁴⁰¹, R⁴⁰², R⁴⁰³, R⁴⁰⁴, or R⁴⁰⁵ represents a hydroxyl group, and at least one of R⁴⁰¹, R⁴⁰², R⁴⁰³, R⁴⁰⁴, or R⁴⁰⁵ represents a carboxyl group,

Condition (ii): At least two of R⁴⁰¹, R⁴⁰², R⁴⁰³, R⁴⁰⁴, and R⁴⁰⁵ represent a carboxyl group,

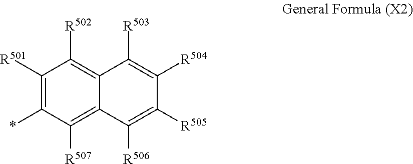

in which, in the General Formula (X2), R⁵⁰¹, R⁵⁰², R⁵⁰³, R⁵⁰⁴, R⁵⁰⁵, R⁵⁰⁶, and R⁵⁰⁷ each independently represent a hydrogen atom, an alkyl group, an aryl group, a hydroxyl group, a halogen atom, a nitro group, a trifluoromethyl group, a carboxyl group, or a sulfo group; R⁵⁰¹, R⁵⁰², R⁵⁰³, R⁵⁰⁴, R⁵⁰⁵, R⁵⁰⁶, and R⁵⁰⁷ satisfy the following condition (iii) or (iv); and * denotes a direct bond to a sulfur atom,

Condition (iii): At least one of R⁵⁰¹, R⁵⁰², R⁵⁰³, R⁵⁰⁴, R⁵⁰⁵, R⁵⁰⁶, or R⁵⁰⁷ represents a hydroxyl group, and at least one of R⁵⁰¹, R⁵⁰², R⁵⁰³, R⁵⁰⁴, R⁵⁰⁵, R⁵⁰⁶, or R⁵⁰⁷ represents a carboxyl group,

Condition (iv): At least two of R⁵⁰¹, R⁵⁰², R⁵⁰³, R⁵⁰⁴, R⁵⁰⁵, R⁵⁰⁶, and R⁵⁰⁷ represent a carboxyl group,

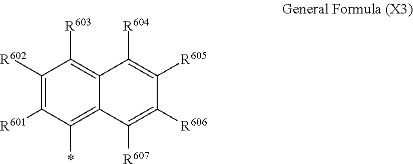

in which, in the General Formula (X3), R⁶⁰¹, R⁶⁰², R⁶⁰³, R⁶⁰⁴, R⁶⁰⁵, R⁶⁰⁶, and R⁶⁰⁷ each independently represent a hydrogen atom, an alkyl group, an aryl group, a hydroxyl group, a halogen atom, a nitro group, a trifluoromethyl group, a carboxyl group, or a sulfo group; R⁶⁰¹, R⁶⁰², R⁶⁰³, R⁶⁰⁴, R⁶⁰⁵, R⁶⁰⁶, and R⁶⁰⁷ satisfy the following condition (v) or (vi); and * denotes a direct bond to a sulfur atom,

Condition (v): At least one of R⁶⁰¹, R⁶⁰², R⁶⁰³, R⁶⁰⁴, R⁶⁰⁵, R⁶⁰⁶, or R⁶⁰⁷ represents a hydroxyl group, and at least one of R⁶⁰¹, R⁶⁰², R⁶⁰³, R⁶⁰⁴, R⁶⁰⁵, R⁶⁰⁶, or R⁶⁰⁷ represents a carboxyl group,

Condition (vi): At least two of R⁶⁰¹, R⁶⁰², R⁶⁰³, R⁶⁰⁴, R⁶⁰⁵, R⁶⁰⁶, and R⁶⁰⁷ represent a carboxyl group, and

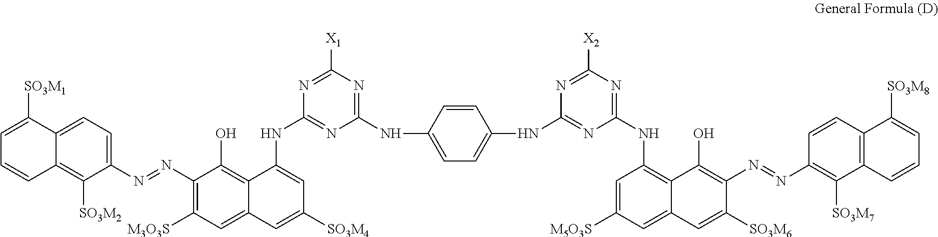

in which, in the General Formula (D), X₁ and X₂ each independently represent a chlorine atom, a hydroxyl group, or an amino group; and M₁ to M₈ each independently represent a hydrogen atom, an ammonium ion, an alkali metal ion, or an organic cation.

[2] The coloring composition described in [1], in which the X of the General Formula (A) represents a substituent represented by the General Formula (X1) and the R⁴⁰¹, R⁴⁰², R⁴⁰³, R⁴⁰⁴, and R⁴⁰⁵ of the General Formula (X1) satisfy the condition (i).

[3] The coloring composition described in [1], in which the X of the General Formula (A) represents a substituent represented by the General Formula (X2) and the R⁵⁰¹, R⁵⁰², R⁵⁰³, R⁵⁰⁴, R⁵⁰⁵, R⁵⁰⁶, and R⁵⁰⁷ of the General Formula (X2) satisfy the condition (iii).

[4] The coloring composition described in [1], in which the X of the General Formula (A) represents a substituent represented by the General Formula (X3) and the R⁶⁰¹, R⁶⁰², R⁶⁰³, R⁶⁰⁴, R⁶⁰⁵, R⁶⁰⁶, and R⁶⁰⁷ of the General Formula (X3) satisfy the condition (v).

[5] The coloring composition described in any one of [1] to [4], in which a total content of the compound represented by the General Formula (1) and the compound represented by the General Formula (D) in the coloring composition is 3.5% by mass or less.

[6] The coloring composition described in any one of [1] to [5], in which the mass ratio {General Formula (1)/General Formula (D)} of the content of the compound represented by the General Formula (1) to the content of the compound represented by the General Formula (D) is {99/1} to {60/40}.

[7] An ink for ink jet recording, the ink including the coloring composition described in any one of [1] to [6].

[8] An ink jet recording method in which the ink for ink jet recording described in [7] is used.

[9] An ink jet printer cartridge including the ink for ink jet recording described in [7].

According to the present invention, a coloring composition that enables the formation of an image that has a magenta hue, a high chroma, and a high print density and that is excellent in terms of light resistance, ozone resistance, and moisture resistance, the coloring composition being also excellent in terms of long-term storage stability, an ink for ink jet recording which includes the coloring composition, an ink jet recording method in which the ink for ink jet recording is used, and an ink jet printer cartridge including the ink for ink jet recording may be provided.

### DESCRIPTION OF THE PREFERRED EMBODIMENTS

Details of the present invention are described below.

In the present invention, in the case where a compound is a salt, the salt is present in a water-soluble ink while being dissociated into ions.

### Compound Represented by General Formula (1)

The compound represented by General Formula (1) below is described.

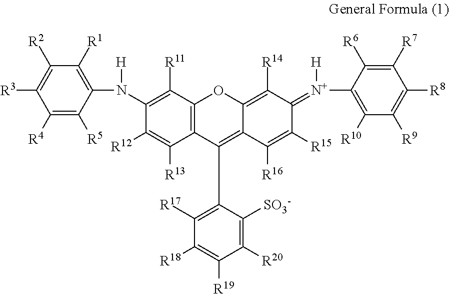

In General Formula (1), R¹, R⁵, R⁶, and R¹⁰ each independently represent an alkyl group; R⁴, R⁹, R¹¹, R¹², R¹³, R¹⁴, R¹⁵, R¹⁶, R¹⁷, R¹⁸, R¹⁹, and R²⁰ each independently represent a hydrogen atom, an alkyl group, an aryl group, a halogen atom, a carboxyl group, or a sulfo group; R², R³, R⁷, and R⁸ each independently represent a hydrogen atom, an alkyl group, or the substituent represented by General Formula (A) below; and at least one of R², R³, R⁷, or R⁸ represents the substituent represented by General Formula (A) below.

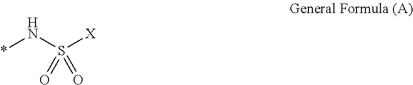

In General Formula (A), X represents a substituent represented by General Formula (X1), (X2), or (X3) below; and * denotes a direct bond to a benzene ring.

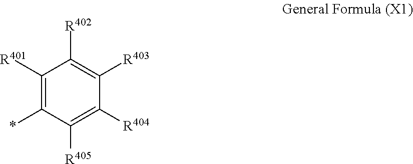

In General Formula (X1), R⁴⁰¹, R⁴⁰², R⁴⁰³, R⁴⁰⁴, and R⁴⁰⁵ each independently represent a hydrogen atom, an alkyl group, an aryl group, a hydroxyl group, a halogen atom, a nitro group, a trifluoromethyl group, a carboxyl group, or a sulfo group; R⁴⁰¹, R⁴⁰², R⁴⁰³, R⁴⁰⁴, and R⁴⁰⁵ satisfy the condition (i) or (ii) below; and * denotes a direct bond to a sulfur atom.

Condition (i): At least one of R⁴⁰¹, R⁴⁰², R⁴⁰³, R⁴⁰⁴, or R⁴⁰⁵ represents a hydroxyl group, and at least one of R⁴⁰¹, R⁴⁰², R⁴⁰³, R⁴⁰⁴, or R⁴⁰⁵ represents a carboxyl group,

Condition (ii): At least two of R⁴⁰¹, R⁴⁰², R⁴⁰³, R⁴⁰⁴, and R⁴⁰⁵ represent a carboxyl group.

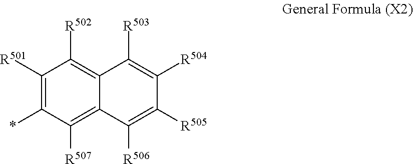

In General Formula (X2), R⁵⁰¹, R⁵⁰², R⁵⁰³, R⁵⁰⁴, R⁵⁰⁵, R⁵⁰⁶, and R⁵⁰⁷ each independently represent a hydrogen atom, an alkyl group, an aryl group, a hydroxyl group, a halogen atom, a nitro group, a trifluoromethyl group, a carboxyl group, or a sulfo group; R⁵⁰¹, R⁵⁰², R⁵⁰³, R⁵⁰⁴, R⁵⁰⁵, R⁵⁰⁶, and R⁵⁰⁷ satisfy the condition (iii) or (iv) below; and * denotes a direct bond to a sulfur atom.

Condition (iii): At least one of R⁵⁰¹, R⁵⁰², R⁵⁰³, R⁵⁰⁴, R⁵⁰⁵, R⁵⁰⁶, or R⁵⁰⁷ represents a hydroxyl group, and at least one of R⁵⁰¹, R⁵⁰², R⁵⁰³, R⁵⁰⁴, R⁵⁰⁵, R⁵⁰⁶, or R⁵⁰⁷ represents a carboxyl group,

Condition (iv): At least two of R⁵⁰¹, R⁵⁰², R⁵⁰³, R⁵⁰⁴, R⁵⁰⁵, R⁵⁰⁶, and R⁵⁰⁷ represent a carboxyl group.

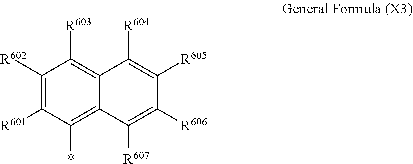

In General Formula (X3), R⁶⁰¹, R⁶⁰², R⁶⁰³, R⁶⁰⁴, R⁶⁰⁵, R⁶⁰⁶, and R⁶⁰⁷ each independently represent a hydrogen atom, an alkyl group, an aryl group, a hydroxyl group, a halogen atom, a nitro group, a trifluoromethyl group, a carboxyl group, or a sulfo group; R⁶⁰¹, R⁶⁰², R⁶⁰³, R⁶⁰⁴, R⁶⁰⁵, R⁶⁰⁶, and R⁶⁰⁷ satisfy the condition (v) or (vi) below; and * denotes a direct bond to a sulfur atom.

Condition (v): At least one of R⁶⁰¹, R⁶⁰², R⁶⁰³, R⁶⁰⁴, R⁶⁰⁵, R⁶⁰⁶, or R⁶⁰⁷ represents a hydroxyl group, and at least one of R⁶⁰¹, R⁶⁰², R⁶⁰³, R⁶⁰⁴, R⁶⁰⁵, R⁶⁰⁶, or R⁶⁰⁷ represents a carboxyl group,

Condition (vi): At least two of R⁶⁰¹, R⁶⁰², R⁶⁰³, R⁶⁰⁴, R⁶⁰⁵, R⁶⁰⁶, and R⁶⁰⁷ represent a carboxyl group.

In General Formula (1), R¹¹, R¹³, R¹⁴, R¹⁶, R¹⁷, R¹⁸, R¹⁹, and R²⁰ each independently represent a hydrogen atom, an alkyl group, an aryl group, a halogen atom, a carboxyl group, or a sulfo group.

It is preferable that R¹¹, R¹³, R¹⁴, R¹⁶, R¹⁷, R¹⁸, R¹⁹, and R²⁰ represent a hydrogen atom.

In General Formula (1), R¹, R⁵, R⁶, and R¹⁰ each independently represent an alkyl group. In consideration of the availability of raw materials and ease of synthesis, the alkyl group is preferably an alkyl group having 1 to 6 carbon atoms, is more preferably an alkyl group having 1 to 3 carbon atoms, and is further preferably a methyl or ethyl group.

In General Formula (1), R⁴, R⁹, R¹², and R¹⁵ each independently represent a hydrogen atom, an alkyl group, an aryl group, a halogen atom, a carboxyl group, or a sulfo group. It is preferable that R⁴, R⁹, R¹², and R¹⁵ each independently represent a hydrogen atom, an alkyl group, a carboxyl group, or a sulfo group.

The alkyl group is preferably an alkyl group having 1 to 6 carbon atoms, is more preferably an alkyl group having 1 to 3 carbon atoms, is further preferably a methyl or ethyl group, and is particularly preferably a methyl group.

The carboxyl group and the sulfo group may be in the form of either a free acid or a salt. In the case where the carboxyl group and the sulfo group are in the form of a salt, examples of the countercation include an alkali metal cation (preferably, a lithium ion, a sodium ion, or a potassium ion; particularly preferably, a sodium ion), an ammonium ion, and an organic cation (e.g., a tetramethylammonium ion, a tetramethylguanidinium ion, or tetramethylphosphonium ion). In consideration of ease of synthesis (ease of handling as a dye powder), the countercation is preferably an alkali metal cation.

It is preferable that at least one of R⁴, R⁹, R¹², or R¹⁵ represent a carboxyl or sulfo group. It is more preferable that two or more of R⁴, R⁹, R¹², and R¹⁵ represent a carboxyl or sulfo group.

It is preferable that R¹² and R¹⁵ represent a carboxyl or sulfo group and R⁴ and R⁹ represent a hydrogen atom or that R⁴ and R⁹ represent a carboxyl or sulfo group and R¹² and R¹⁵ represent a hydrogen atom. It is more preferable that R¹² and R¹⁵ represent a carboxyl or sulfo group and R⁴ and R⁹ represent a hydrogen atom. It is most preferable that R¹² and R¹⁵ represent a sulfo group and R⁴ and R⁹ represent a hydrogen atom.

R⁴ and R⁹ preferably each independently represent a hydrogen atom, a sulfo group, or a carboxyl group, more preferably each independently represent a hydrogen atom or a sulfo group, and most preferably each independently represent a hydrogen atom.

R¹² and R¹⁵ preferably each independently represent a hydrogen atom, a sulfo group, or a carboxyl group, more preferably each independently represent a hydrogen atom or a sulfo group, and most preferably each independently represent a sulfo group.

In General Formula (1), R², R³, R⁷, and R⁸ each independently represent a hydrogen atom, an alkyl group, or the substituent represented by General Formula (A) above; and at least one of R², R³, R⁷, or R⁸ represents the substituent represented by General Formula (A) above.

In the case where R², R³, R⁷, and R⁸ represent an alkyl group, the alkyl group is preferably an alkyl group having 1 to 6 carbon atoms, is more preferably an alkyl group having 1 to 3 carbon atoms, and is further preferably a methyl or ethyl group.

It is preferable that R² and R⁷ each independently represent the substituent represented by General Formula (A) and R³ and R⁸ represent an alkyl group or that R³ and R⁸ each independently represent the substituent represented by General Formula (A) and R² and R⁷ represent an alkyl group. It is more preferable that R² and R⁷ each independently represent the substituent represented by General Formula (A) and R³ and R⁸ represent an alkyl group. It is further preferable that R² and R⁷ represent the substituent represented by General Formula (A) and R³ and R⁸ represent an alkyl group having 1 to 3 carbon atoms. It is most preferable that R² and R⁷ represent the substituent represented by General Formula (A) and R³ and R⁸ represent a methyl group.

In General Formula (A), X represents a substituent represented by General Formula (X1), (X2), or (X3) above.

Note that the carboxyl group in General Formula (X1), (X2), or (X3) may be in the form of either a free acid or a salt. In the case where the carboxyl group is in the form of a salt, examples of the countercation include an alkali metal cation (preferably, a lithium ion, a sodium ion, or a potassium ion; particularly preferably, a sodium ion), an ammonium ion, and an organic cation (e.g., a tetramethylammonium ion, a tetramethylguanidinium ion, or tetramethylphosphonium). The countercation is preferably an alkali metal cation.

In General Formula (X1), R⁴⁰¹, R⁴⁰², R⁴⁰³, R⁴⁰⁴, and R⁴⁰⁵ each independently represent a hydrogen atom, an alkyl group, an aryl group, a hydroxyl group, a halogen atom, a nitro group, a trifluoromethyl group, a carboxyl group, or a sulfo group; and R⁴⁰¹, R⁴⁰², R⁴⁰³, R⁴⁰⁴, and R⁴⁰⁵ satisfy the condition (i) or (ii) below.

Condition (i): At least one of R⁴⁰¹, R⁴⁰², R⁴⁰³, R⁴⁰⁴, or R⁴⁰⁵ represents a hydroxyl group, and at least one of R⁴⁰¹, R⁴⁰², R⁴⁰³, R⁴⁰⁴, or R⁴⁰⁵ represents a carboxyl group.

Condition (ii): At least two of R⁴⁰¹, R⁴⁰², R⁴⁰³, R⁴⁰⁴, and R⁴⁰⁵ represent a carboxyl group.

It is preferable that, in General Formula (X1), R⁴⁰¹, R⁴⁰², R⁴⁰³, R⁴⁰⁴, and R⁴⁰⁵ satisfy the condition (i). In other words, it is preferable that at least one of R⁴⁰¹, R⁴⁰², R⁴⁰³, R⁴⁰⁴, or R⁴⁰⁵ represent a hydroxyl group, and at least one of R⁴⁰¹, R⁴⁰², R⁴⁰³, R⁴⁰⁴, or R⁴⁰⁵ represent a carboxyl group.

The number of hydroxyl groups represented by R⁴⁰¹, R⁴⁰², R⁴⁰³, R⁴⁰⁴, and R⁴⁰⁵ is preferably 1 to 3, is more preferably 1 or 2, and is further preferably 1. The number of carboxyl groups represented by R⁴⁰¹, R⁴⁰², R⁴⁰³, R⁴⁰⁴, and R⁴⁰⁵ is more preferably 1 to 3, is further preferably 1 or 2, and is particularly preferably 1.

It is preferable that R⁴⁰³ represent a hydroxyl group and R⁴⁰² represent a carboxyl group or that R⁴⁰¹ represent a hydroxyl group and at least one of R⁴⁰² or R⁴⁰⁴ represent a carboxyl group. It is particularly preferable that R⁴⁰¹ represent a hydroxyl group and R⁴⁰² and R⁴⁰⁴ represent a carboxyl group.

In the case where R⁴⁰¹, R⁴⁰², R⁴⁰³, R⁴⁰⁴, and R⁴⁰⁵ represent an alkyl group, the alkyl group is preferably an alkyl group having 1 to 6 carbon atoms, is more preferably an alkyl group having 1 to 3 carbon atoms, and is particularly preferably a methyl group.

In another aspect other than the above, it is also preferable that the condition (i) or (ii) be satisfied and R⁴⁰¹, R⁴⁰², R⁴⁰³, R⁴⁰⁴, and R⁴⁰⁵ represent a carboxyl group, a chlorine atom, a nitro group, or a trifluoromethyl group. A carboxyl group, a chlorine atom, or a nitro group is more preferable. A carboxyl group is further preferable. In particular, it is preferable that, in the case where R⁴⁰¹ represents a hydroxyl group and R⁴⁰² represents a carboxyl group, R⁴⁰⁴ represent a carboxyl group, a chlorine atom, a nitro group, or a trifluoromethyl group.

In the case where, in General Formula (X1), R⁴⁰¹, R⁴⁰², R⁴⁰³, R⁴⁰⁴, and R⁴⁰⁵ satisfy the condition (ii), it is preferable that R⁴⁰¹ represent a hydrogen atom, a methyl group, a nitro group, or a chlorine atom, R⁴⁰² and R⁴⁰⁴ represent a carboxyl group, and R⁴⁰³ and R⁴⁰⁵ represent a hydrogen atom; it is further preferable that R⁴⁰¹ represent a hydrogen atom or a methyl group, R⁴⁰² and R⁴⁰⁴ represent a carboxyl group, and R⁴⁰³ and R⁴⁰⁵ represent a hydrogen atom; and it is particularly preferable that R⁴⁰¹, R⁴⁰³, and R⁴⁰⁵ represent a hydrogen atom and R⁴⁰² and R⁴⁰⁴ represent a carboxyl group.

Specific examples of the group represented by General Formula (X1) are described below. Note that the group represented by General Formula (X1) is not limited to the following examples. In the structural formulae of the specific compounds below, “Me” denotes a methyl group and “*” denotes a direct bond to a sulfur atom.

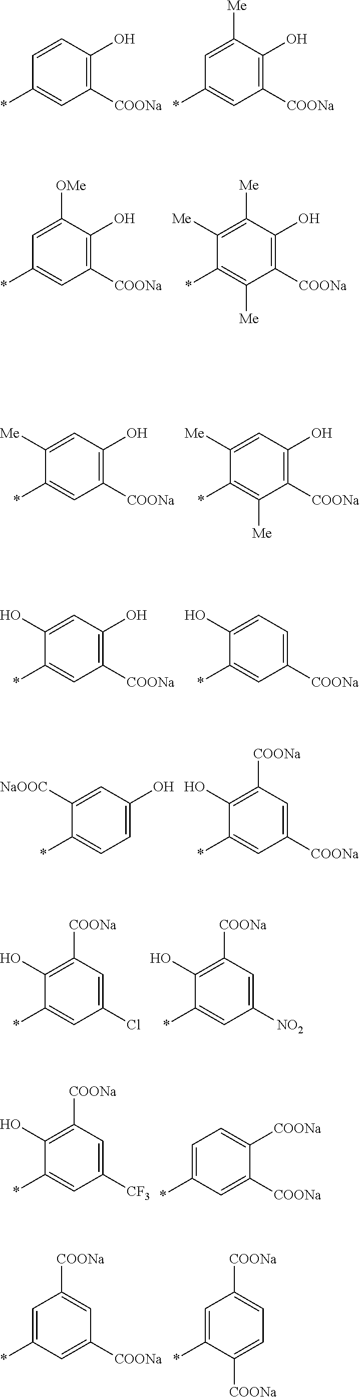

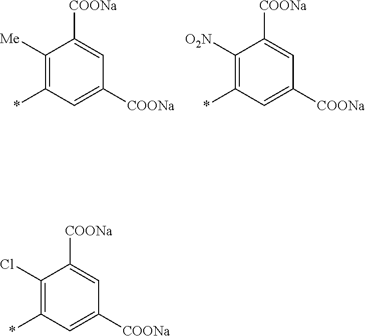

In General Formula (X2), R⁵⁰¹, R⁵⁰², R⁵⁰³, R⁵⁰⁴, R⁵⁰⁵, R⁵⁰⁶, and R⁵⁰⁷ each independently represent a hydrogen atom, an alkyl group, an aryl group, a hydroxyl group, a halogen atom, a nitro group, a trifluoromethyl group, a carboxyl group, or a sulfo group; and R⁵⁰¹, R⁵⁰², R⁵⁰³, R⁵⁰⁴, R⁵⁰⁵, R⁵⁰⁶, and R⁵⁰⁷ satisfy the condition (iii) or (iv) below.

Condition (iii): At least one of R⁵⁰¹, R⁵⁰², R⁵⁰³, R⁵⁰⁴, R⁵⁰⁵, R⁵⁰⁶, or R⁵⁰⁷ represents a hydroxyl group, and at least one of R⁵⁰¹, R⁵⁰², R⁵⁰³, R⁵⁰⁴, R⁵⁰⁵, R⁵⁰⁶, or R⁵⁰⁷ represents a carboxyl group.

Condition (iv): At least two of R⁵⁰¹, R⁵⁰², R⁵⁰³, R⁵⁰⁴, R⁵⁰⁵, R⁵⁰⁶, and R⁵⁰⁷ represent a carboxyl group.

It is preferable that, in General Formula (X2), R⁵⁰¹, R⁵⁰², R⁵⁰³, R⁵⁰⁴, R⁵⁰⁵, R⁵⁰⁶, and R⁵⁰⁷ satisfy the condition (iii). In other words, it is preferable that at least one of R⁵⁰¹, R⁵⁰², R⁵⁰³, R⁵⁰⁴, R⁵⁰⁵, R⁵⁰⁶, or R⁵⁰⁷ represent a hydroxyl group, and at least one of R⁵⁰¹, R⁵⁰², R⁵⁰³, R⁵⁰⁴, R⁵⁰⁵, R⁵⁰⁶, or R⁵⁰⁷ represent a carboxyl group.

In the case where R⁵⁰¹, R⁵⁰², R⁵⁰³, R⁵⁰⁴, R⁵⁰⁵, R⁵⁰⁶, and R⁵⁰⁷ represent an alkyl group, the alkyl group is preferably an alkyl group having 1 to 6 carbon atoms, is more preferably an alkyl group having 1 to 3 carbon atoms, and is particularly preferably a methyl group.

The number of hydroxyl groups represented by R⁵⁰¹, R⁵⁰², R⁵⁰³, R⁵⁰⁴, R⁵⁰⁵, R⁵⁰⁶, and R⁵⁰⁷ is preferably 1 to 3, is more preferably 1 or 2, and is further preferably 1. The number of carboxyl groups represented by R⁵⁰¹, R⁵⁰², R⁵⁰³, R⁵⁰⁴, R⁵⁰⁵, R⁵⁰⁶, and R⁵⁰⁷ is more preferably 1 or 2 and is further preferably 1.

It is preferable that R⁵⁰⁴ represent a hydroxyl group and R⁵⁰³ represent a carboxyl group or that R⁵⁰⁴ represent a hydroxyl group and R⁵⁰⁵ represent a carboxyl group. It is more preferable that R⁵⁰⁴ represent a hydroxyl group and R⁵⁰³ represent a carboxyl group.

Specific examples of the group represented by General Formula (X2) are described below. Note that the group represented by General Formula (X2) is not limited to the following examples. The symbol “*” denotes a direct bond to a sulfur atom.

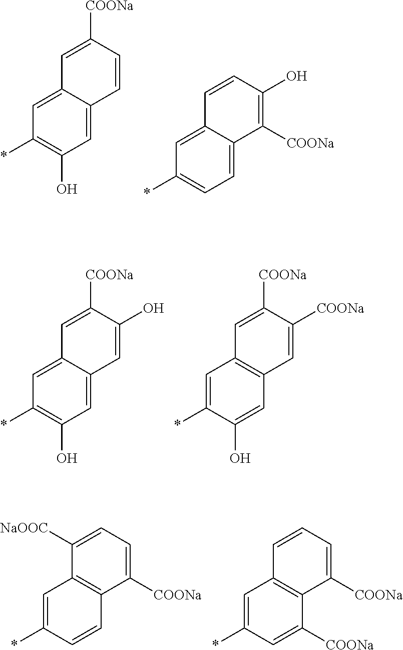

In General Formula (X3), R⁶⁰¹, R⁶⁰², R⁶⁰³, R⁶⁰⁴, R⁶⁰⁵, R⁶⁰⁶, and R⁶⁰⁷ each independently represent a hydrogen atom, an alkyl group, an aryl group, a hydroxyl group, a halogen atom, a nitro group, a trifluoromethyl group, a carboxyl group, or a sulfo group; and R⁶⁰¹, R⁶⁰², R⁶⁰³, R⁶⁰⁴, R⁶⁰⁵, R⁶⁰⁶, and R⁶⁰⁷ satisfy the condition (v) or (vi) below. Note that * denotes a direct bond to a sulfur atom.

Condition (v): At least one of R⁶⁰¹, R⁶⁰², R⁶⁰³, R⁶⁰⁴, R⁶⁰⁵, R⁶⁰⁶, or R⁶⁰⁷ represents a hydroxyl group, and at least one of R⁶⁰¹, R⁶⁰², R⁶⁰³, R⁶⁰⁴, R⁶⁰⁵, R⁶⁰⁶, or R⁶⁰⁷ represents a carboxyl group.

Condition (vi): At least two of R⁶⁰¹, R⁶⁰², R⁶⁰³, R⁶⁰⁴, R⁶⁰⁵, R⁶⁰⁶, and R⁶⁰⁷ represent a carboxyl group.

It is preferable that, in General Formula (X3), R⁶⁰¹, R⁶⁰², R⁶⁰³, R⁶⁰⁴, R⁶⁰⁵, R⁶⁰⁶, and R⁶⁰⁷ satisfy the condition (v). In other words, it is preferable that at least one of R⁶⁰¹, R⁶⁰², R⁶⁰³, R⁶⁰⁴, R⁶⁰⁵, R⁶⁰⁶, or R⁶⁰⁷ represent a hydroxyl group, and at least one of R⁶⁰¹, R⁶⁰², R⁶⁰³, R⁶⁰⁴, R⁶⁰⁵, R⁶⁰⁶, or R⁶⁰⁷ represent a carboxyl group.

In the case where R⁶⁰¹, R⁶⁰², R⁶⁰³, R⁶⁰⁴, R⁶⁰⁵, R⁶⁰⁶, and R⁶⁰⁷ represent an alkyl group, the alkyl group is preferably an alkyl group having 1 to 6 carbon atoms, is more preferably an alkyl group having 1 to 3 carbon atoms, and is particularly preferably a methyl group.

The number of hydroxyl groups represented by R⁶⁰¹, R⁶⁰², R⁶⁰³, R⁶⁰⁴, R⁶⁰⁵, R⁶⁰⁶, and R⁶⁰⁷ is preferably 1 to 3, is more preferably 1 or 2, and is further preferably 1. The number of carboxyl groups represented by R⁶⁰¹, R⁶⁰², R⁶⁰³, R⁶⁰⁴, R⁶⁰⁵, R⁶⁰⁶, and R⁶⁰⁷ is more preferably 1 or 2 and is further preferably 1.

It is preferable that R⁶⁰⁶ represent a hydroxyl group and R⁶⁰⁵ represent a carboxyl group or that R⁶⁰³ represent a hydroxyl group and R⁶⁰² represent a carboxyl group. It is more preferable that R⁶⁰⁶ represent a hydroxyl group and R⁶⁰⁵ represent a carboxyl group.

Specific examples of the group represented by General Formula (X3) are described below. Note that the group represented by General Formula (X3) is not limited to the following examples. The symbol “*” denotes a direct bond to a sulfur atom.

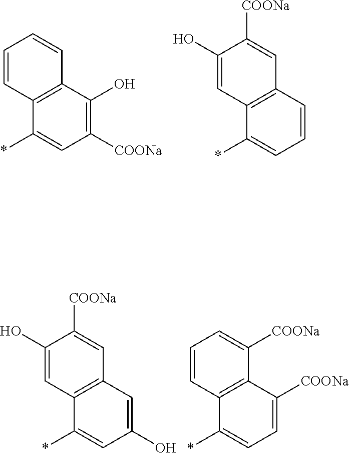

The compound represented by General Formula (1) above is preferably the compound represented by General Formula (2), (3), or (4) below.

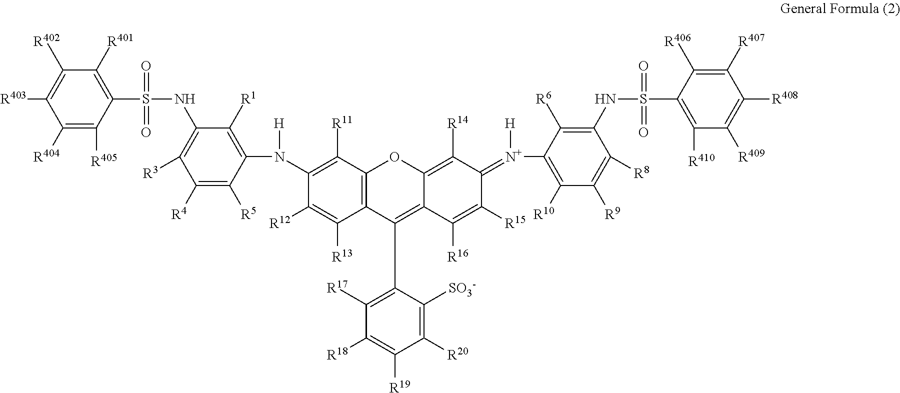

In General Formula (2), R¹, R⁵, R⁶, and R¹⁰ each independently represent an alkyl group; R⁴, R⁹, R¹¹, R¹², R¹³, R¹⁴, R¹⁵, R¹⁶, R¹⁷, R¹⁸, R¹⁹, and R²⁰ each independently represent a hydrogen atom, an alkyl group, an aryl group, a halogen atom, a carboxyl group, or a sulfo group; R³ and R⁸ each independently represent a hydrogen atom or an alkyl group; R⁴⁰¹, R⁴⁰², R⁴⁰³, R⁴⁰⁴, and R⁴⁰⁵ each independently represent a hydrogen atom, an alkyl group, an aryl group, a hydroxyl group, a halogen atom, a nitro group, a trifluoromethyl group, a carboxyl group, or a sulfo group; R⁴⁰¹, R⁴⁰², R⁴⁰³, R⁴⁰⁴, and R⁴⁰⁵ satisfy the condition (i-1) or (ii-1) below; R⁴⁰⁶, R⁴⁰⁷, R⁴⁰⁸, R⁴⁰⁹, and R⁴¹⁰ each independently represent a hydrogen atom, an alkyl group, an aryl group, a hydroxyl group, a halogen atom, a nitro group, a trifluoromethyl group, a carboxyl group, or a sulfo group; and R⁴⁰⁶, R⁴⁰⁷, R⁴⁰⁸, R⁴⁰⁹, and R⁴¹⁰ satisfy the condition (i-2) or (ii-2) below.

Condition (i-1): At least one of R⁴⁰¹, R⁴⁰², R⁴⁰³, R⁴⁰⁴, or R⁴⁰⁵ represents a hydroxyl group, and at least one of R⁴⁰¹, R⁴⁰², R⁴⁰³, R⁴⁰⁴, or R⁴⁰⁵ represents a carboxyl group.

Condition (ii-1): At least two of R⁴⁰¹, R⁴⁰², R⁴⁰³, R⁴⁰⁴, and R⁴⁰⁵ represent a carboxyl group.

Condition (i-2): At least one of R⁴⁰⁶, R⁴⁰⁷, R⁴⁰⁸, R⁴⁰⁹, or R⁴¹⁰ represents a hydroxyl group, and at least one of R⁴⁰⁶, R⁴⁰⁷, R⁴⁰⁸, R⁴⁰⁹, or R⁴¹⁰ represents a carboxyl group.

Condition (ii-2): At least two of R⁴⁰⁶, R⁴⁰⁷, R⁴⁰⁸, R⁴⁰⁹, and R⁴¹⁰ represent a carboxyl group.

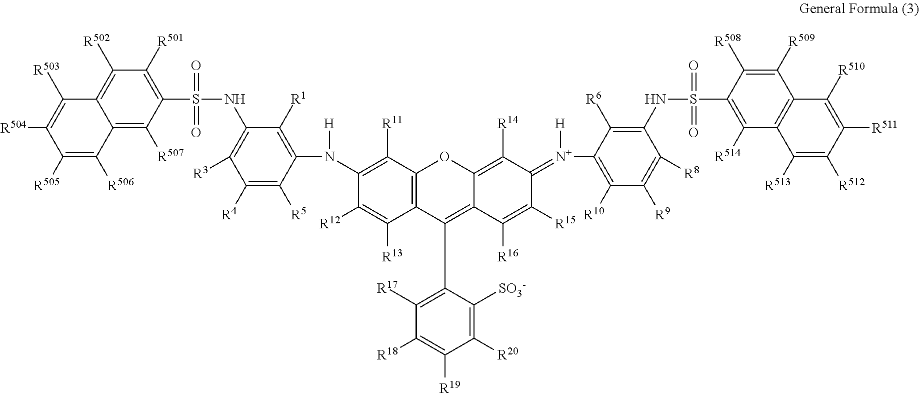

In General Formula (3), R¹, R⁵, R⁶, and R¹⁰ each independently represent an alkyl group; R⁴, R⁹, R¹¹, R¹², R¹³, R¹⁴, R¹⁵, R¹⁶, R¹⁷, R¹⁸, R¹⁹, and R²⁰ each independently represent a hydrogen atom, an alkyl group, an aryl group, a halogen atom, a carboxyl group, or a sulfo group; R³ and R⁸ each independently represent a hydrogen atom or an alkyl group; R⁵⁰¹, R⁵⁰², R⁵⁰³, R⁵⁰⁴, R⁵⁰⁵, R⁵⁰⁶, and R⁵⁰⁷ each independently represent a hydrogen atom, an alkyl group, an aryl group, a hydroxyl group, a halogen atom, a nitro group, a trifluoromethyl group, a carboxyl group, or a sulfo group; R⁵⁰¹, R⁵⁰², R⁵⁰³, R⁵⁰⁴, R⁵⁰⁵, R⁵⁰⁶, and R⁵⁰⁷ satisfy the condition (iii-1) or (iv-1) below; R⁵⁰⁸, R⁵⁰⁹, R⁵¹⁰, R⁵¹¹, R⁵¹², R⁵¹³, and R⁵¹⁴ each independently represent a hydrogen atom, an alkyl group, an aryl group, a hydroxyl group, a halogen atom, a nitro group, a trifluoromethyl group, a carboxyl group, or a sulfo group; and R⁵⁰⁸, R⁵⁰⁹, R⁵¹⁰, R⁵¹¹, R⁵¹², R⁵¹³, and R⁵¹⁴ satisfy the condition (iii-2) or (iv-2) below.

Condition (iii-1): At least one of R⁵⁰¹, R⁵⁰², R⁵⁰³, R⁵⁰⁴, R⁵⁰⁵, R⁵⁰⁶, or R⁵⁰⁷ represents a hydroxyl group, and at least one of R⁵⁰¹, R⁵⁰², R⁵⁰³, R⁵⁰⁴, R⁵⁰⁵, R⁵⁰⁶, or R⁵⁰⁷ represents a carboxyl group.

Condition (iv-1): At least two of R⁵⁰¹, R⁵⁰², R⁵⁰³, R⁵⁰⁴, R⁵⁰⁵, R⁵⁰⁶, and R⁵⁰⁷ represent a carboxyl group.

Condition (iii-2): At least one of R⁵⁰⁸, R⁵⁰⁹, R⁵¹⁰, R⁵¹¹, R⁵¹², R⁵¹³, or R⁵¹⁴ represents a hydroxyl group, and at least one of R⁵⁰⁸, R⁵⁰⁹, R⁵¹⁰, R⁵¹¹, R⁵¹², R⁵¹³, or R⁵¹⁴ represents a carboxyl group.

Condition (iv-2): At least two of R⁵⁰⁸, R⁵⁰⁹, R⁵¹⁰, R⁵¹¹, R⁵¹², R⁵¹³, and R⁵¹⁴ represent a carboxyl group.

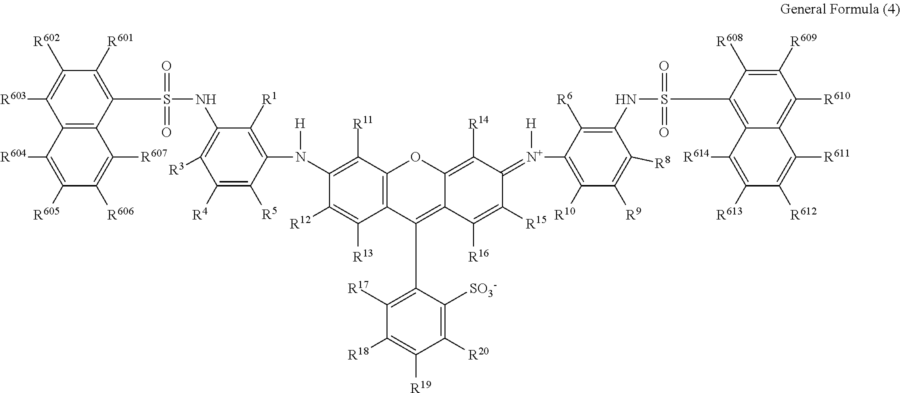

In General Formula (4), R¹, R⁵, R⁶, and R¹⁰ each independently represent an alkyl group; R⁴, R⁹, R¹¹, R¹², R¹³, R¹⁴, R¹⁵, R¹⁶, R¹⁷, R¹⁸, R¹⁹, and R²⁰ each independently represent a hydrogen atom, an alkyl group, an aryl group, a halogen atom, a carboxyl group, or a sulfo group; R³ and R⁸ each independently represent a hydrogen atom or an alkyl group; R⁶⁰¹, R⁶⁰², R⁶⁰³, R⁶⁰⁴, R⁶⁰⁵, R⁶⁰⁶, and R⁶⁰⁷ each independently represent a hydrogen atom, an alkyl group, an aryl group, a hydroxyl group, a halogen atom, a nitro group, a trifluoromethyl group, a carboxyl group, or a sulfo group; R⁶⁰¹, R⁶⁰², R⁶⁰³, R⁶⁰⁴, R⁶⁰⁵, R⁶⁰⁶, and R⁶⁰⁷ satisfy the condition (v-1) or (vi-1) below; R⁶⁰⁸, R⁶⁰⁹, R⁶¹⁰, R⁶¹¹, R⁶¹², R⁶¹³, and R⁶¹⁴ each independently represent a hydrogen atom, an alkyl group, an aryl group, a hydroxyl group, a halogen atom, a nitro group, a trifluoromethyl group, a carboxyl group, or a sulfo group; and R⁶⁰⁸, R⁶⁰⁹, R⁶¹⁰, R⁶¹¹, R⁶¹², R⁶¹³, and R⁶¹⁴ satisfy the condition (v-2) or (vi-2) below.

Condition (v-1): At least one of R⁶⁰¹, R⁶⁰², R⁶⁰³, R⁶⁰⁴, R⁶⁰⁵, R⁶⁰⁶, or R⁶⁰⁷ represents a hydroxyl group, and at least one of R⁶⁰¹, R⁶⁰², R⁶⁰³, R⁶⁰⁴, R⁶⁰⁵, R⁶⁰⁶, or R⁶⁰⁷ represents a carboxyl group.

Condition (vi-1): At least two of R⁶⁰¹, R⁶⁰², R⁶⁰³, R⁶⁰⁴, R⁶⁰⁵, R⁶⁰⁶, and R⁶⁰⁷ represent a carboxyl group.

Condition (v-2): At least one of R⁶⁰⁸, R⁶⁰⁹, R⁶¹⁰, R⁶¹¹, R⁶¹², R⁶¹³, or R⁶¹⁴ represents a hydroxyl group, and at least one of R⁶⁰⁸, R⁶⁰⁹, R⁶¹⁰, R⁶¹¹, R⁶¹², R⁶¹³, or R⁶¹⁴ represents a carboxyl group.

Condition (vi-2): At least two of R⁶⁰⁸, R⁶⁰⁹, R⁶¹⁰, R⁶¹¹, R⁶¹², R⁶¹³, and R⁶¹⁴ represent a carboxyl group.

R¹, R⁴, R⁵, R⁶, R⁹, R¹⁰, R¹¹, R¹², R¹³, R¹⁴, R¹⁵, R¹⁶, R¹⁷, R¹⁸, R¹⁹, and R²⁰ in General Formula (2) have the same meanings as R¹, R⁴, R⁵, R⁶, R⁹, R¹⁰, R¹¹, R¹², R¹³, R¹⁴, R¹⁵, R¹⁶, R¹⁷, R¹⁸, R¹⁹, and R²⁰ in General Formula (1), respectively. The same applies to the preferable ranges thereof.

In General Formula (2), R³ and R⁸ each independently represent a hydrogen atom or an alkyl group and preferably represent an alkyl group. The alkyl group is preferably an alkyl group having 1 to 6 carbon atoms, is more preferably an alkyl group having 1 to 3 carbon atoms, and is further preferably a methyl or ethyl group.

It is preferable that, in General Formula (2), R⁴⁰¹, R⁴⁰², R⁴⁰³, R⁴⁰⁴, and R⁴⁰⁵ satisfy the condition (i-1) above. In other words, it is preferable that at least one of R⁴⁰¹, R⁴⁰², R⁴⁰³, R⁴⁰⁴, or R⁴⁰⁵ represent a hydroxyl group, and at least one of R⁴⁰¹, R⁴⁰², R⁴⁰³, R⁴⁰⁴, or R⁴⁰⁵ represent a carboxyl group. The preferable ranges of R⁴⁰¹, R⁴⁰², R⁴⁰³, R⁴⁰⁴, and R⁴⁰⁵ are the same as those of R⁴⁰¹, R⁴⁰², R⁴⁰³, R⁴⁰⁴, and R⁴⁰⁵ in General Formula (X1), respectively.

It is preferable that, in General Formula (2), R⁴⁰⁶, R⁴⁰⁷, R⁴⁰⁸, R⁴⁰⁹, and R⁴¹⁰ satisfy the condition (i-2) above. In other words, it is preferable that at least one of R⁴⁰⁶, R⁴⁰⁷, R⁴⁰⁸, R⁴⁰⁹, or R⁴¹⁰ represent a hydroxyl group, and at least one of R⁴⁰⁶, R⁴⁰⁷, R⁴⁰⁸, R⁴⁰⁹, or R⁴¹⁰ represent a carboxyl group. The preferable ranges of R⁴⁰⁶, R⁴⁰⁷, R⁴⁰⁸, R⁴⁰⁹, and R⁴¹⁰ are the same as those of R⁴⁰¹, R⁴⁰², R⁴⁰³, R⁴⁰⁴, and R⁴⁰⁵ in General Formula (2), respectively.

R¹, R⁴, R⁵, R⁶, R⁹, R¹⁰, R¹¹, R¹², R¹³, R¹⁴, R¹⁵, R¹⁶, R¹⁷, R¹⁸, R¹⁹, and R²⁰ in General Formula (3) have the same meanings as R¹, R⁴, R⁵, R⁶, R⁹, R¹⁰, R¹¹, R¹², R¹³, R¹⁴, R¹⁵, R¹⁶, R¹⁷, R¹⁸, R¹⁹, and R²⁰ in General Formula (1), respectively. The same applies to the preferable ranges thereof.

In General Formula (3), R³ and R⁸ each independently represent a hydrogen atom or an alkyl group and preferably represent an alkyl group. The alkyl group is preferably an alkyl group having 1 to 6 carbon atoms, is more preferably an alkyl group having 1 to 3 carbon atoms, and is further preferably a methyl or ethyl group.

It is preferable that, in General Formula (3), R⁵⁰¹, R⁵⁰², R⁵⁰³, R⁵⁰⁴, R⁵⁰⁵, R⁵⁰⁶, and R⁵⁰⁷ satisfy the condition (iii-1) above. In other words, it is preferable that at least one of R⁵⁰¹, R⁵⁰², R⁵⁰³, R⁵⁰⁴, R⁵⁰⁵, R⁵⁰⁶, or R⁵⁰⁷ represent a hydroxyl group, and at least one of R⁵⁰¹, R⁵⁰², R⁵⁰³, R⁵⁰⁴, R⁵⁰⁵, R⁵⁰⁶, or R⁵⁰⁷ represent a carboxyl group. The preferable ranges of R⁵⁰¹, R⁵⁰², R⁵⁰³, R⁵⁰⁴, R⁵⁰⁵, R⁵⁰⁶, and R⁵⁰⁷ are the same as those of R⁵⁰¹, R⁵⁰², R⁵⁰³, R⁵⁰⁴, R⁵⁰⁵, R⁵⁰⁶, and R⁵⁰⁷ in General Formula (X2), respectively.

It is preferable that, in General Formula (3), R⁵⁰⁸, R⁵⁰⁹, R⁵¹⁰, R⁵¹¹, R⁵¹², R⁵¹³, and R⁵¹⁴ satisfy the condition (iii-2) above. In other words, it is preferable that at least one of R⁵⁰⁸, R⁵⁰⁹, R⁵¹⁰, R⁵¹¹, R⁵¹², R⁵¹³, or R⁵¹⁴ represent a hydroxyl group, and at least one of R⁵⁰⁸, R⁵⁰⁹, R⁵¹⁰, R⁵¹¹, R⁵¹², R⁵¹³, or R⁵¹⁴ represent a carboxyl group. The preferable ranges of R⁵⁰⁸, R⁵⁰⁹, R⁵¹⁰, R⁵¹¹, R⁵¹², R⁵¹³, and R⁵¹⁴ are the same as those of R⁵⁰¹, R⁵⁰², R⁵⁰³, R⁵⁰⁴, R⁵⁰⁵, R⁵⁰⁶, and R⁵⁰⁷ in General Formula (3), respectively.

R¹, R⁴, R⁵, R⁶, R⁹, R¹⁰, R¹¹, R¹², R¹³, R¹⁴, R¹⁵, R¹⁶, R¹⁷, R¹⁸, R¹⁹, and R²⁰ in General Formula (4) have the same meanings as R¹, R⁴, R⁵, R⁶, R⁹, R¹⁰, R¹¹, R¹², R¹³, R¹⁴, R¹⁵, R¹⁶, R¹⁷, R¹⁸, R¹⁹, and R²⁰ in General Formula (1), respectively. The same applies to the preferable ranges thereof.

In General Formula (4), R³ and R⁸ each independently represent a hydrogen atom or an alkyl group and preferably represent an alkyl group. The alkyl group is preferably an alkyl group having 1 to 6 carbon atoms, is more preferably an alkyl group having 1 to 3 carbon atoms, and is further preferably a methyl or ethyl group.

It is preferable that, in General Formula (4), R⁶⁰¹, R⁶⁰², R⁶⁰³, R⁶⁰⁴, R⁶⁰⁵, R⁶⁰⁶, and R⁶⁰⁷ satisfy the condition (v-1) above. In other words, it is preferable that at least one of R⁶⁰¹, R⁶⁰², R⁶⁰³, R⁶⁰⁴, R⁶⁰⁵, R⁶⁰⁶, or R⁶⁰⁷ represent a hydroxyl group, and at least one of R⁶⁰¹, R⁶⁰², R⁶⁰³, R⁶⁰⁴, R⁶, R⁶⁰⁶, or R⁶⁰⁷ represent a carboxyl group. The preferable ranges of R⁶⁰¹, R⁶⁰², R⁶⁰³, R⁶⁰⁴, R⁶⁰⁵, R⁶⁰⁶, and R⁶⁰⁷ are the same as those of R⁶⁰¹, R⁶⁰², R⁶⁰³, R⁶⁰⁴, R⁶⁰⁵, R⁶⁰⁶, and R⁶⁰⁷ in General Formula (X3), respectively.

It is preferable that, in General Formula (4), R⁶⁰⁸, R⁶⁰⁹, R⁶¹⁰, R⁶¹¹, R⁶¹², R⁶¹³, and R⁶¹⁴ satisfy the condition (v-2) above. In other words, it is preferable that at least one of R⁶⁰⁸, R⁶⁰⁹, R⁶¹⁰, R⁶¹¹, R⁶¹², R⁶¹³, or R⁶¹⁴ represent a hydroxyl group, and at least one of R⁶⁰⁸, R⁶⁰⁹, R⁶¹⁰, R⁶¹¹, R⁶¹², R⁶¹³, or R⁶¹⁴ represent a carboxyl group. The preferable ranges of R⁶⁰⁸, R⁶⁰⁹, R⁶¹⁰, R⁶¹¹, R⁶¹², R⁶¹³, and R⁶¹⁴ are the same as those of R⁶⁰¹, R⁶⁰², R⁶⁰³, R⁶⁰⁴, R⁶⁰⁵, R⁶⁰⁶, and R⁶⁰⁷ in General Formula (4), respectively.

Specific examples of the compound represented by General Formula (1) are described below. Note that the compound represented by General Formula (1) is not limited to the following examples. In the structural formulae of the specific compounds below, “Me” denotes a methyl group and “Et” denotes an ethyl group.

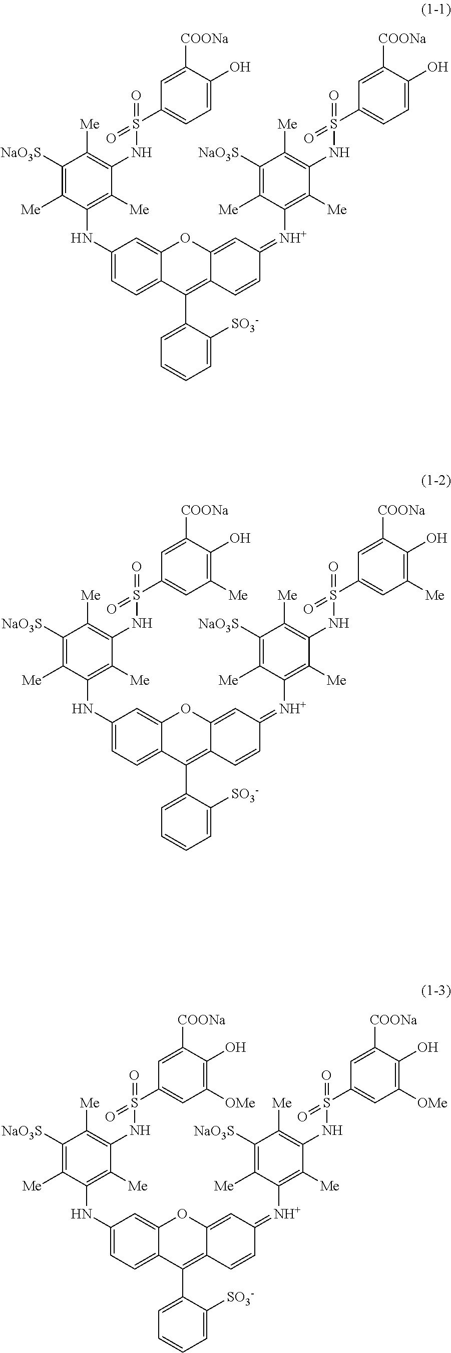

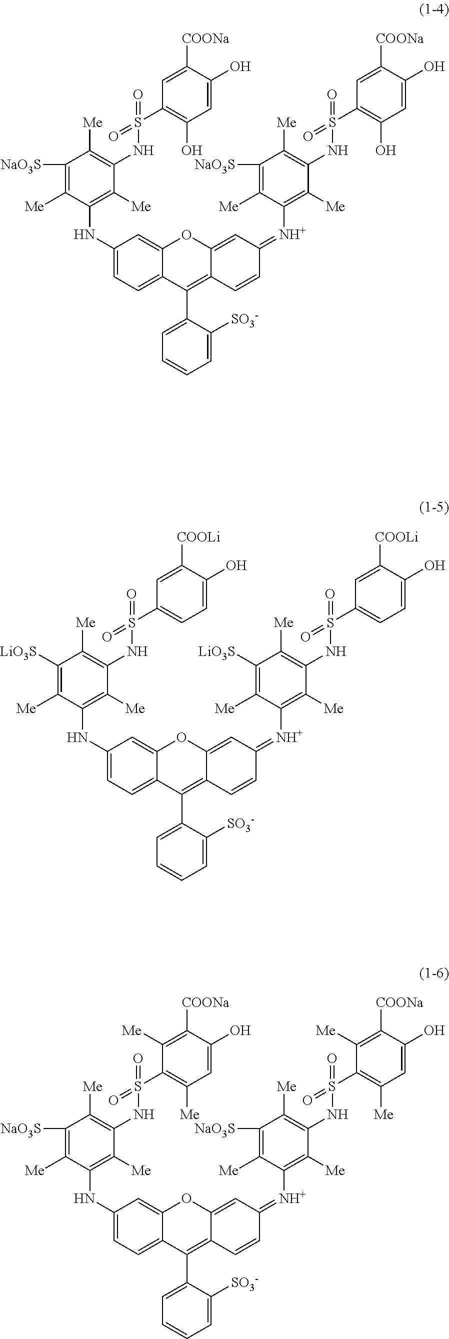

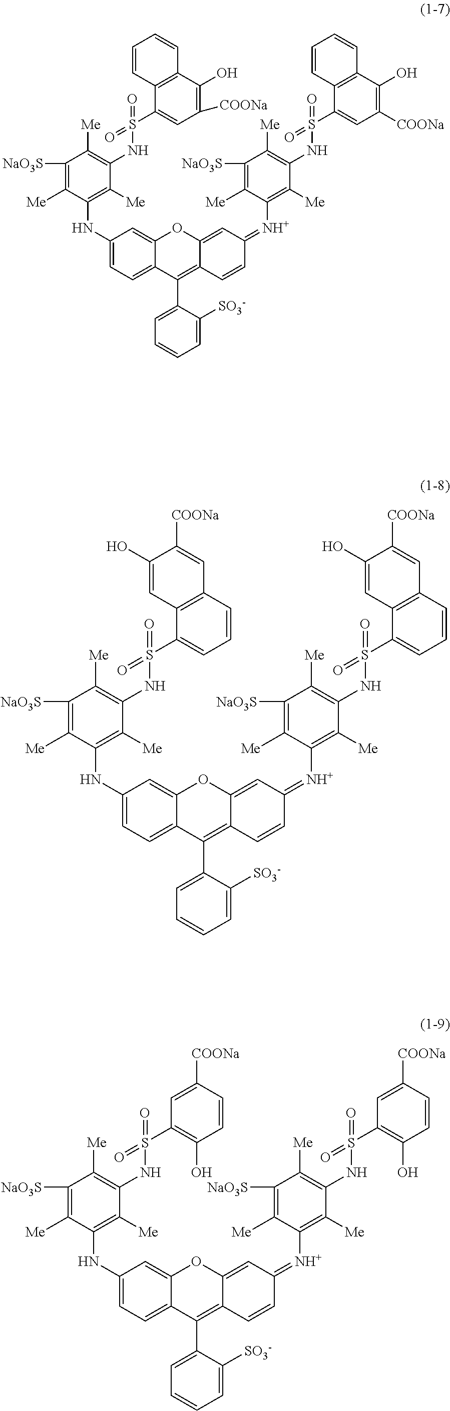

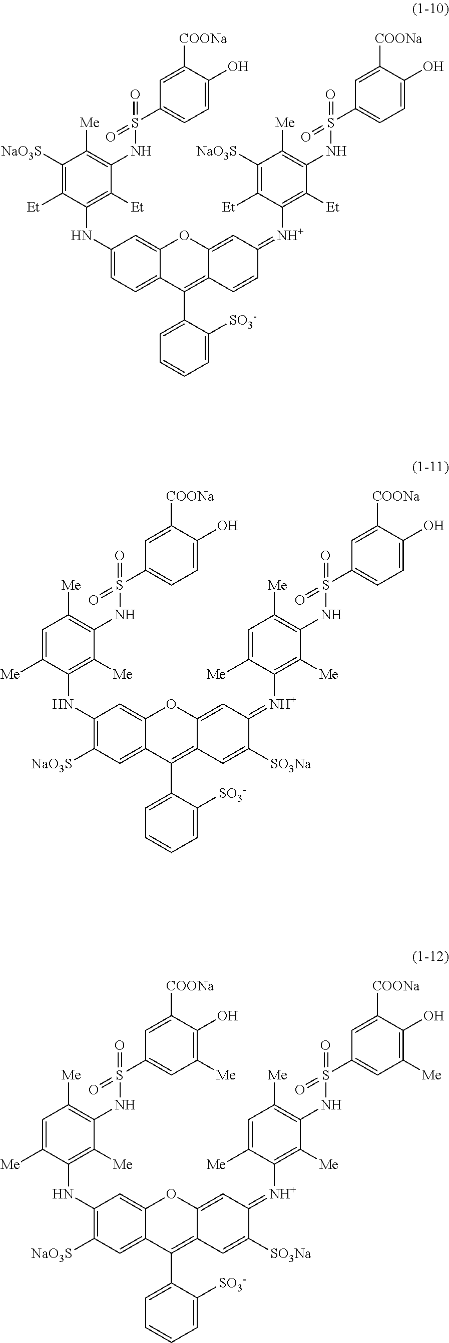

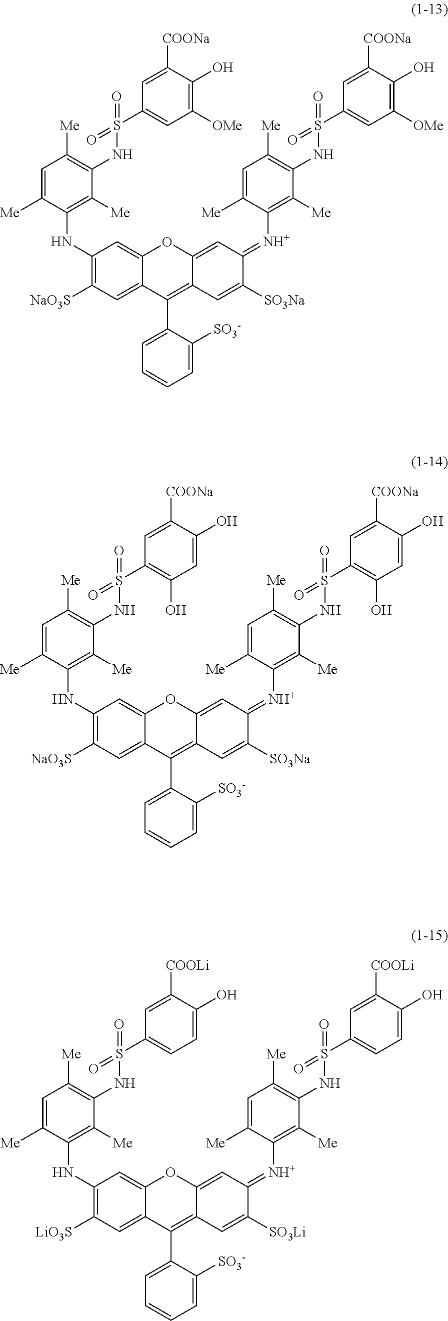

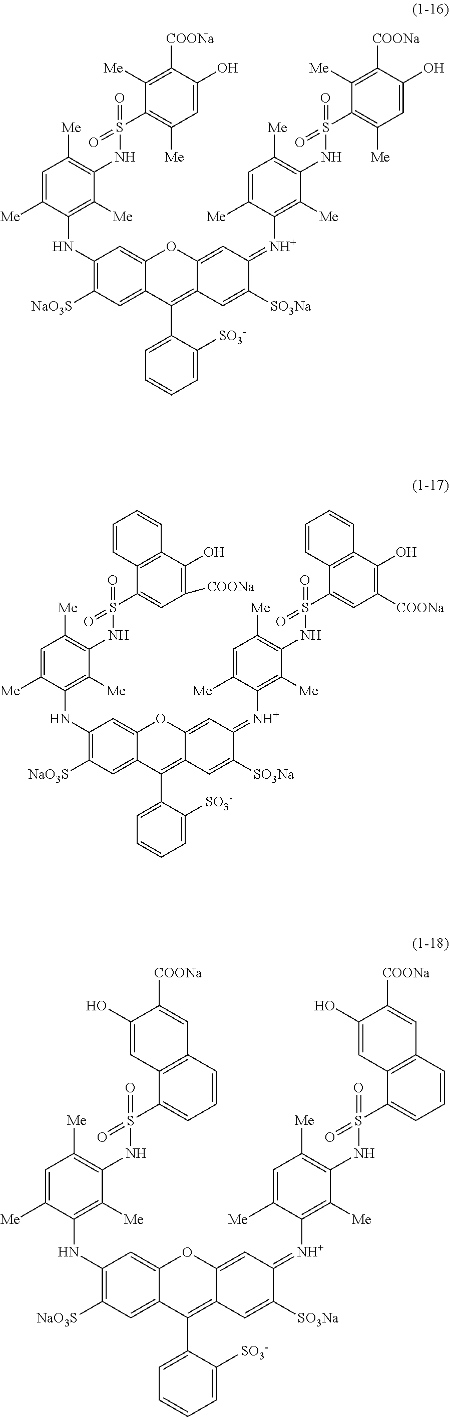

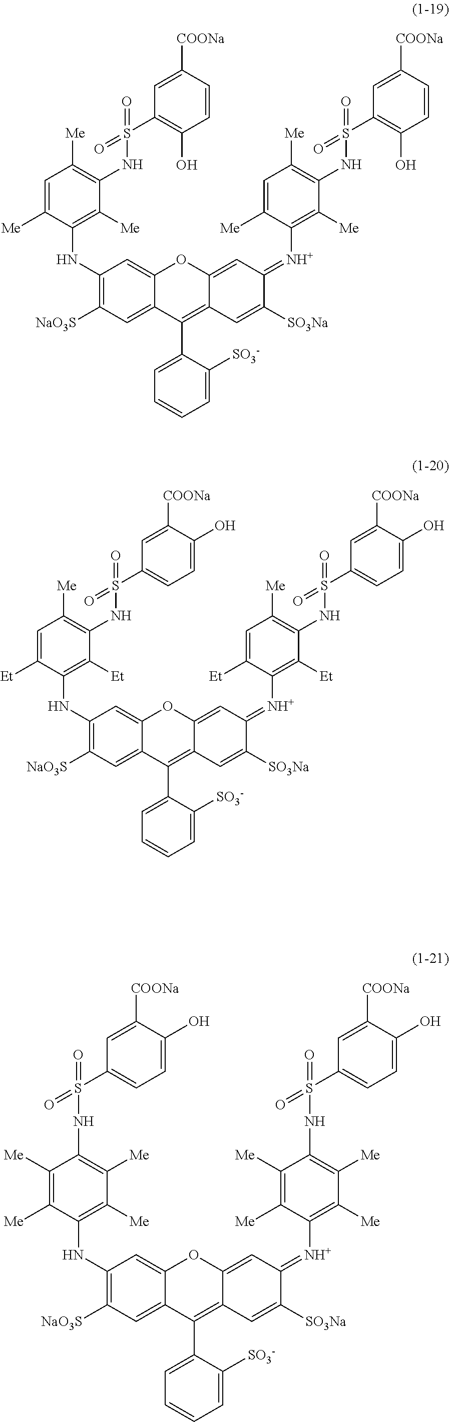

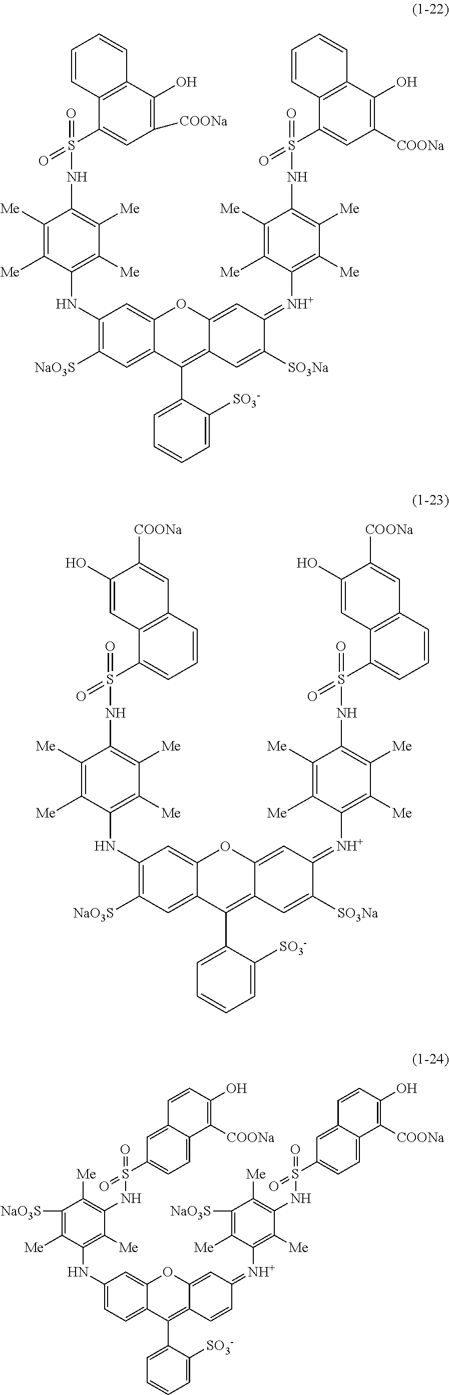

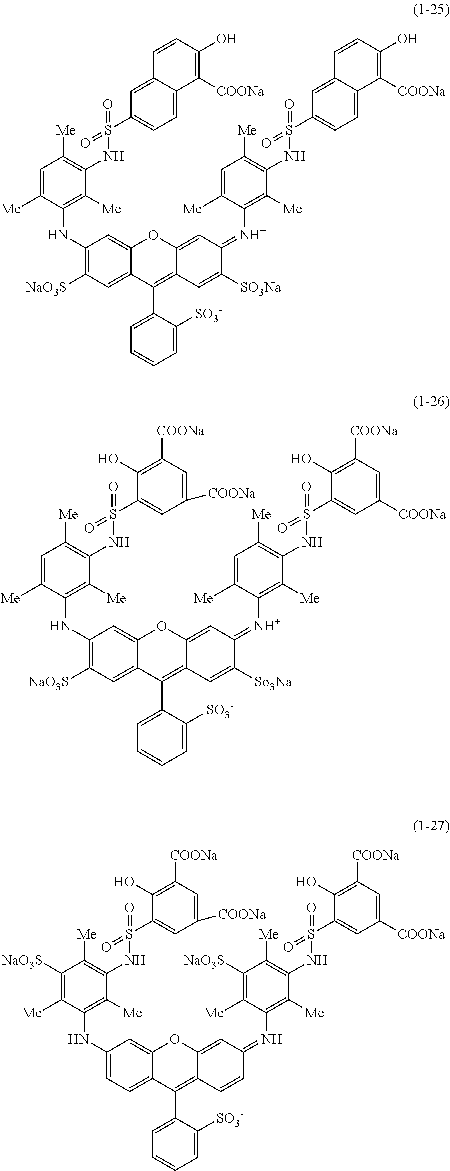

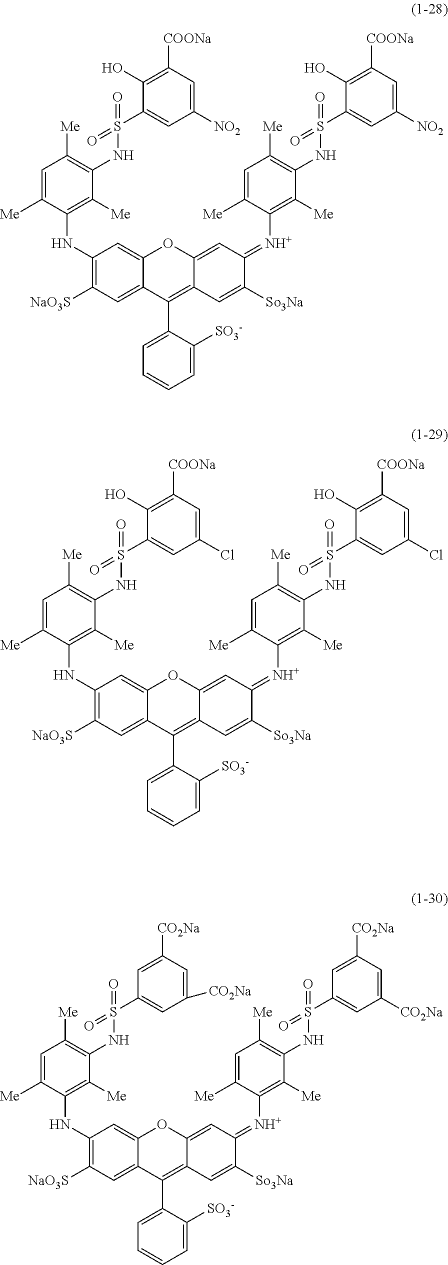

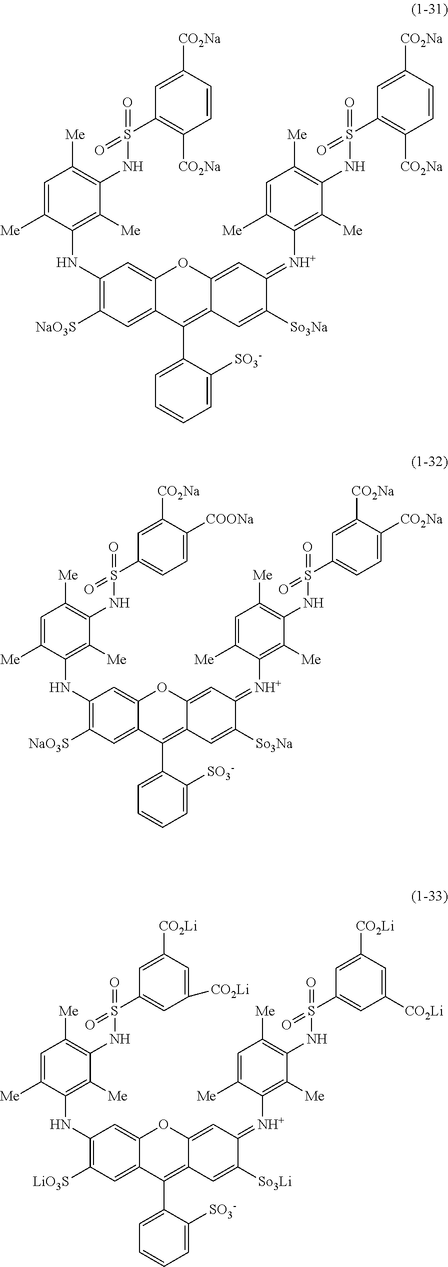

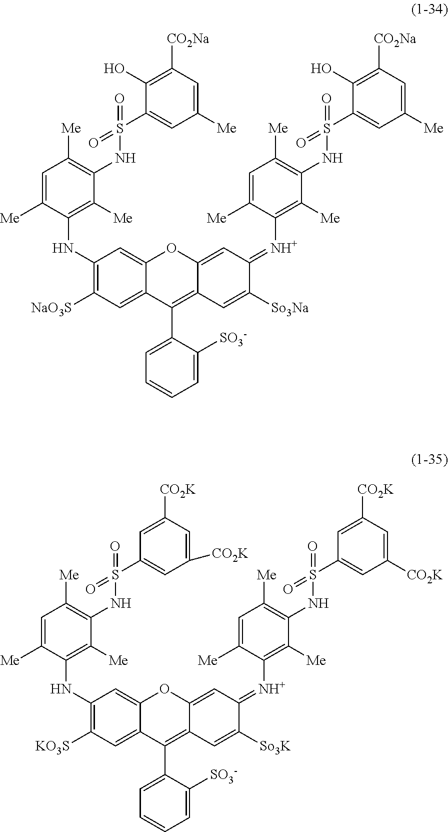

The compound represented by General Formula (1) can be synthesized using a common synthesis method known in the related art (e.g., the method described in Paragraphs [0150] to [0165] of WO2018/062044A).

### Compound Represented by General Formula (D)

The compound represented by General Formula (D) is described below.

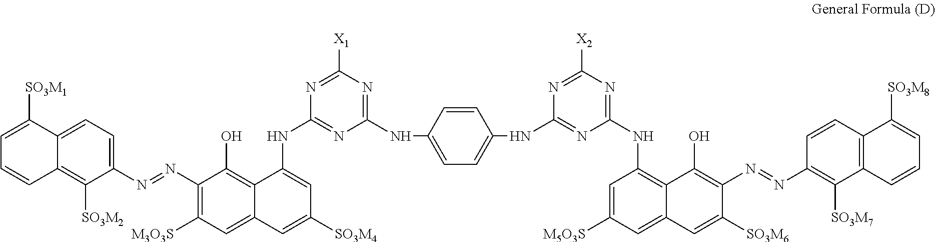

In General Formula (D), X₁ and X₂ each independently represent a chlorine atom, a hydroxyl group, or an amino group; and M₁ to M₈ each independently represent a hydrogen atom, an ammonium ion, an alkali metal ion, or an organic cation.

X₁ and X₂ preferably represent a chlorine atom or a hydroxyl group and most preferably represent a chlorine atom in consideration of the availability of raw materials.

Examples of the organic cation include a tetramethylammonium ion, a tetramethylguanidinium ion, and tetramethylphosphonium ion.

M₁ to M₈ preferably represent a hydrogen atom, an ammonium ion, or an alkali metal ion and most preferably represent a hydrogen atom or an alkali metal ion. The alkali metal ion is preferably a potassium ion, a sodium ion, or a lithium ion, is more preferably a lithium ion or a sodium ion, and is most preferably a sodium ion.

In consideration of solubility in water, it is preferable that four to eight of M₁ to M₈ of the compound represented by General Formula (D) represent an alkali metal ion, it is more preferable that five to eight of M₁ to M₈ represent an alkali metal ion, and it is further preferable that six to eight of M₁ to M₈ represent an alkali metal ion.

Specific examples of the compound represented by General Formula (D) are described below. Note that the compound represented by General Formula (D) is not limited to the following examples. In the specific examples below, —SO₃M₁ to —SO₃M₈ may be in the form of either a free acid (—SO₃H) or a salt (—SO₃⁻M⁺), where M⁺ represents a countercation.

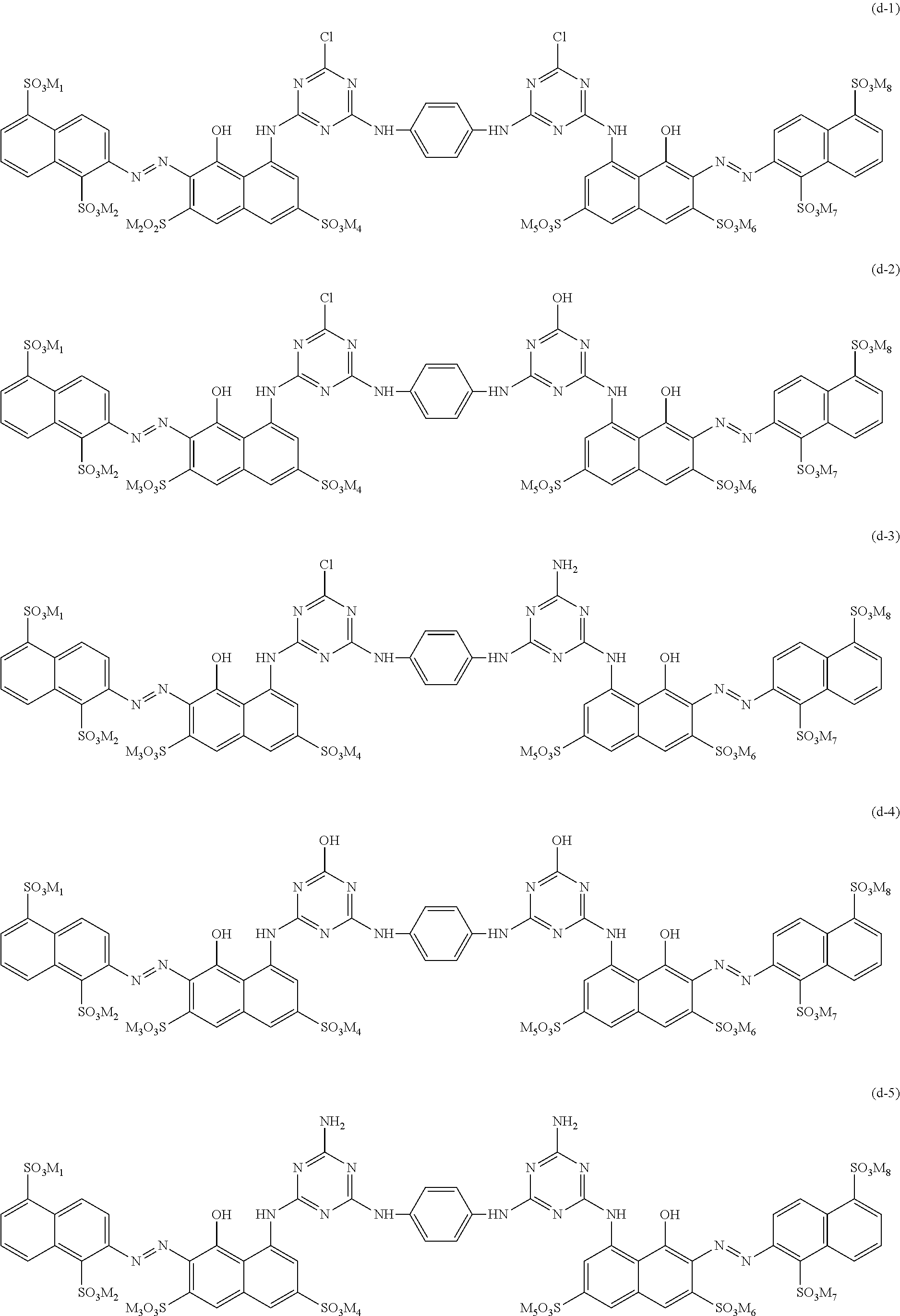

The compound represented by General Formula (D) is most preferably the compound (d-1-Na). The compound (d-1-Na) is C.I. Reactive Red 141 (CAS: 61931-52-0).

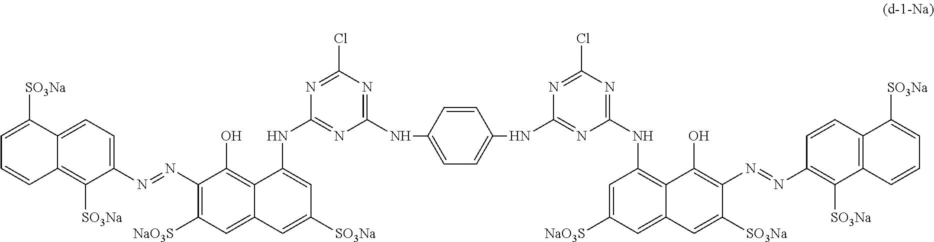

### Coloring Composition

The coloring composition according to the present invention includes the compound represented by General Formula (1) above and the compound represented by General Formula (D) above.

The coloring composition according to the present invention may further include a medium. In the case where a solvent is used as a medium, the coloring composition is particularly suitable as an ink for ink jet recording. The coloring composition according to the present invention can be produced by dissolving and/or dispersing the compound represented by General Formula (1) above and the compound represented by General Formula (D) above using at least one of a lipophilic medium or an aqueous medium as a medium. It is preferable to use an aqueous medium. The coloring composition according to the present invention may also be a composition for inks which does not include a medium.

The content of the compound represented by General Formula (1) above in the coloring composition is not limited because it can be determined in accordance with the type of the compound represented by General Formula (1) used, the type of the solvent component used for producing the coloring composition, and the like. The content of the compound represented by General Formula (1) in the coloring composition is preferably 0.1% to 20.0% by mass, is more preferably 0.2% to 10.0% by mass, is further preferably 1.0% to 5.0% by mass, is particularly preferably 1.0% to 3.5% by mass, and is most preferably 2.0% by mass or more and less than 3.5% by mass of the total mass of the coloring composition.

The content of the compound represented by General Formula (D) above in the coloring composition is preferably, but not limited to, 0.1% to 3.0% by mass, is more preferably 0.1% to 2.5% by mass, is further preferably 0.1% to 2.0% by mass, and is most preferably 0.2% to 1.5% by mass of the total mass of the coloring composition.

The total content of the compound represented by General Formula (1) above and the compound represented by General Formula (D) above in the coloring composition is preferably 5.0% by mass or less, is more preferably 3.5% by mass or less, and is further preferably 3.0% by mass or less. The total content of the compound represented by General Formula (1) above and the compound represented by General Formula (D) above in the coloring composition is preferably 1.0% by mass or more and is more preferably 2.0% by mass or more.

When the total content of the compound represented by General Formula (1) above and the compound represented by General Formula (D) above in the coloring composition is 1.0% by mass or more, the print density at which the ink is deposited on a printed recording medium can be increased. When the total content of the compound represented by General Formula (1) above and the compound represented by General Formula (D) above in the coloring composition is 3.5% by mass or less, the discharge performance with which the coloring composition is ejected when used in an ink jet recording method can be enhanced. Furthermore, for example, the clogging of ink jet nozzles can be reduced.

The mass ratio of the content of the compound represented by General Formula (1) in the coloring composition to the content of the compound represented by General Formula (D) in the coloring composition, that is, {General Formula (1)/General Formula (D)}, is {99/1} to {50/50}, is preferably {99/1} to {60/40}, is further preferably {99/1} to {80/20}, is particularly preferably {99/1} to {90/10}, and is most preferably {99/1} to {95/5} in order to enhance hue, chroma, print density, light resistance, ozone resistance, moisture resistance, and the long-term storage stability of the coloring composition in a balanced manner.

The coloring composition according to the present invention may further include another additive as needed such that the advantageous effects of the present invention can be achieved. The coloring composition according to the present invention can be suitably used as an ink for ink jet recording.

### Ink for Ink Jet Recording

The ink for ink jet recording can be produced by dissolving and/or dispersing the compound represented by General Formula (1) and the compound represented by General Formula (D) in a lipophilic or aqueous medium. The ink for ink jet recording is preferably an ink that includes an aqueous medium.

The ink for ink jet recording may further include another additive as needed such that the advantageous effects of the present invention can be achieved. Examples of the other additive include the following common additives known in the related art: a drying retarder (humectant), an antifade agent, an emulsification stabilizer, a penetration-enhancing agent, an ultraviolet absorber, an antiseptic agent, an antifungal agent, a pH-controlling agent, a buffering agent, a surface tension modifier, an antifoaming agent, a viscosity modifier, a dispersing agent, a dispersion stabilizer, an anticorrosive, a chelating agent, and a betaine compound. In the case where the ink is an water-soluble ink, these additives can be added directly to the ink liquid. In the case where an oil-soluble dye is used in the form of a dispersion, it is common to prepare the dye dispersion and then add the additives to the dispersion. In another case, the additives may be added to the oil or water phase while the dye dispersion is prepared.

The drying retarder is suitably used to prevent the ink for ink jet recording from being dried at the ink ejection ports of nozzles used in an ink jet recording system and thereby causing clogging.

The drying retarder is preferably an water-soluble organic solvent that has a lower vapor pressure than water. Specific examples thereof include polyhydric alcohols, such as ethylene glycol, propylene glycol, diethylene glycol, polyethylene glycol, thiodiglycol, dithiodiglycol, 2-methyl-1,3-propanediol, 1,2,6-hexanetriol, an acetylene glycol derivative, glycerin, and trimethylolpropane; lower alkyl ethers of polyhydric alcohols, such as ethylene glycol monomethyl (or ethyl) ether, diethylene glycol monomethyl (or ethyl) ether, and triethylene glycol monoethyl (or butyl) ether; hetero rings, such as 2-pyrrolidone, N-methyl-2-pyrrolidone, 1,3-dimethyl-2-imidazolidinone, and N-ethylmorpholine; sulfur-containing compounds, such as sulfolane, dimethyl sulfoxide, and 3-sulfolene; polyfunctional compounds, such as diacetone alcohol and diethanolamine; and urea derivatives. Among these, polyhydric alcohols, such as glycerin and diethylene glycol, are more preferable. The above drying retarders may be used alone or in combination of two or more. The content of the above drying retarders in the ink is preferably 10% to 50% by mass.

The penetration-enhancing agent can be used to enable the ink for ink jet recording to permeate into paper in a further suitable manner. Examples of the penetration-enhancing agent include alcohols, such as ethanol, isopropanol, butanol, di(tri)ethylene glycol monobutyl ether, and 1,2-hexanediol, sodium lauryl sulfate, sodium oleate, and a nonionic surfactant. The above penetration-enhancing agents commonly produce sufficient advantageous effects when the content of the penetration-enhancing agents in the ink is 5% to 30% by mass. It is preferable to use the penetration-enhancing agents in an amount with which the bleeding of printed characters or print through does not occur.

The ultraviolet absorber can be used to enhance the storage stability of images. Examples of the ultraviolet absorber include the benzotriazole-based compounds described in, for example, JP1983-185677A (JP-S58-185677A), JP1986-190537A (JP-S61-190537A), JP1990-782A (JP-H2-782A), JP1993-197075A (JP-H5-197075A), and JP1997-34057A (JP-H9-34057A); benzophenone-based compounds described in, for example, JP1971-2784A (JP-S46-2784A), JP1993-194483A (JP-H5-194483A), and U.S. Pat. No. 3,214,463A; cinnamic acid-based compounds described in, for example, JP1973-30492A (JP-S48-30492A), JP1981-21141A (JP-S56-21141A), and JP1998-88106A (JP-H10-88106A); triazine-based compounds described in, for example, JP1992-298503A (JP-H4-298503A), JP1996-53427A (JP-H8-53427A), JP1996-239368A (JP-H8-239368A), JP1998-182621A (JP-H10-182621A), and JP1996-501291A (JP-H8-501291A); the compounds described in Research Disclosure No. 24239; and compounds that absorb ultraviolet radiation and emit fluorescent light, that is, “fluorescent brightening agents”, such as stilbene-based compounds and benzoxazole-based compounds.

The antifade agent is used to enhance the storage stability of images. Examples of the antifade agent include various organic antifade agents and various metal complex-based antifade agents. Examples of the organic antifade agents include hydroquinones, alkoxyphenols, dialkoxyphenols, phenols, anilines, amines, indanes, chromanes, alkoxy anilines, and hetero rings. Examples of the metal complexes include a nickel complex and a zinc complex. Specifically, the compounds described in the patents cited in Sections VII-I and J of Research Disclosure No. 17643, Research Disclosure No. 15162, the left column in Page 650 of Research Disclosure No. 18716, Page 527 of Research Disclosure No. 36544, Page 872 of Research Disclosure No. 307105, and Research Disclosure No. 15162; and the compounds represented by the general formula of the typical compounds described in Pages 127 to 137 of JP1987-215272A (JP-S62-215272A) and compounds included in the compound examples described therein can be used.

Examples of the antiseptic agent include an inorganic substance-based antiseptic agent that includes a heavy-metal ion and an organic antiseptic agent. Examples of the organic antiseptic agent include quaternary ammonium salts (e.g., tetrabutylammonium chloride, cetylpyridinium chloride, and benzyltrimethylammonium chloride), phenols (e.g., phenol, cresol, butylphenol, xylenol, and bisphenol), phenoxy ether derivatives (e.g., phenoxyethanol), heterocyclic compounds (e.g., benzotriazole, 1,2-benzisothiazolin-3-one, sodium dehydroacetate, and PROXEL (registered trademark) series produced by LONZA), alkanediols (e.g., pentylene glycol (1,2-pentanediol), isopentyldiol (3-methyl-1,3-butanediol), and hexanediol (1,2-hexanediol)), caprylyl glycols (e.g., 1,2-octanediol), acid amides, carbamic acid, carbamates, amidines and guanidines, pyridines (e.g., sodium pyridinethione-1-oxide), diazines, triazines, pyrroles and imidazoles, oxazoles and oxazines, thiazoles and thiadiazines, thioureas, thiosemicarbazides, dithiocarbamates, sulfides, sulfoxides, sulfones, sulfamides, antibiotics (e.g., penicillin and tetracycline), aromatic carboxylic acids and salts thereof (e.g., sodium benzoate), and aromatic carboxylic acid esters and salts thereof (e.g., p-hydroxybenzoic acid ethyl ester).

The antiseptic agent is preferably at least one selected from the group consisting of a heterocyclic compound, a phenol, a phenoxy ether derivative, and an alkanediol and is more preferably a heterocyclic compound.

As an antiseptic agent, the antiseptic agents described in “Boukin Boubai Handbook” (Handbook of Antimicrobial and Antifungal Agents) (GIHODO: 1986), “Encyclopedia of Antibacterial and Antifungal Agents” (edited by the encyclopedia editorial committee of The Society for Antibacterial and Antifungal Agents, Japan), and the like can also be used.

Among the above compounds, various types of compounds, such as an oil-soluble compound and a water-soluble compound, can be used. A water-soluble compound is preferable.

The ink for ink jet recording may include two or more antiseptic agents.

The heterocyclic compound is preferably a thiazole-based compound or a benzotriazole-based compound.

Among the antiseptic agents, in particular, a thiazole-based compound serves as an antifungal agent. Examples of the thiazole-based compound include benzisothiazoline, isothiazoline, 1,2-benzisothiazolin-3-one, 5-chloro-2-methyl-4-isothiazolin-3-one, 2-(thiocyanomethylthio)benzthiazole, 2-mercaptobenzthiazole, and 3-allyloxy-1,2-benzisothiazole-1,1-oxide. PROXEL (registered trademark) series produced by LONZA) can also be used as a thiazole-based antifungal agent.

Among the antiseptic agents, in particular, a benzotriazole-based compound serves as an anticorrosive and prevents an ink jet head from rusting as a result of, for example, the metal material constituting the ink jet head (specifically, 42 alloy (nickel-iron alloy containing 42% nickel)) coming into contact with the ink. Examples of the benzotriazole-based compound include 1H-benzotriazole, 4-methyl-1H-benzotriazole, 5-methyl-1H-benzotriazole, and sodium or potassium salts thereof.

The content of the antiseptic agent is preferably 0.001% to 10% by mass, is more preferably 0.005% to 2.0% by mass, is further preferably 0.01% to 0.5% by mass, and is particularly preferably 0.01% to 0.1% by mass of the total amount of the ink for ink jet recording.

Examples of the antifungal agent include sodium dehydroacetate, sodium benzoate, sodium pyridinethione-1-oxide, p-hydroxybenzoic acid ethyl ester, 1,2-benzisothiazolin-3-one, and salts thereof. The content of the above antifungal agent in the ink for ink jet recording is preferably 0.02% to 1.00% by mass.

As a pH-controlling agent, a neutralizer (an organic base or an inorganic alkali) can be used. It is preferable to add the pH-controlling agent to the ink for ink jet recording such that the pH of the ink for ink jet recording is 6 to 10 and is preferably 7 to 10 in order to enhance the storage stability of the ink for ink jet recording.

Examples of the surface tension modifier include nonionic, cationic, and anionic surfactants. The surface tension of the ink for ink jet recording according to the present invention is preferably 25 to 70 mN/m and is further preferably 25 to 60 mN/m. The viscosity of the ink for ink jet recording according to the present invention is preferably 30 mPa·s or less and is more preferably adjusted to 20 mPa·s or less. Preferable examples of the surfactant include anionic surfactants, such as a fatty acid salt, an alkyl sulfuric acid ester salt, an alkyl benzenesulfonic acid salt, an alkyl naphthalenesulfonic acid salt, a dialkyl sulfo succinic acid salt, an alkyl phosphoric acid ester salt, a naphthalenesulfonic acid formalin condensate, and a polyoxyethylene alkyl sulfuric acid ester salt; and nonionic surfactants, such as polyoxyethylene alkyl ether, polyoxyethylene alkyl allyl ether, polyoxyethylene fatty acid ester, sorbitan fatty acid ester, polyoxyethylene sorbitan fatty acid ester, polyoxyethylene alkylamine, glycerin fatty acid ester, and an oxyethylene oxypropylene block copolymer. Furthermore, “Surfynol (registered trademark)” series produced by Nissin Chemical Industry Co., Ltd., which are acetylene-based polyoxyethylene oxide surfactants, are also preferably used. Amine oxide-type zwitterionic surfactants, such as N,N-dimethyl-N-alkylamine oxide, are also preferable. In addition, the surfactant examples described in Pages (37) and (38) of JP1984-157,636A (JP-S59-157,636A) and Research Disclosure No. 308119 (1989) can also be used.

As an antifoaming agent, for example, a fluorine compound, a silicone compound, and a chelating agent, such as EDTA, can be used as needed.

The betaine compound can be used to reduce the likelihood of images bleeding under a high-humidity condition. As a betaine compound, the compounds described in, for example, JP2004-285269A can be preferably used. A preferable range of the amount of the above betaine compound added to the ink varies by the type of the betaine compound added. The proportion of the amount of the betaine compound added to the ink for ink jet recording is preferably 0.01% to 10.0% by mass, is more preferably 0.01% to 5.0% by mass, and is most preferably 0.01% to 3.0% by mass.

Chelating Agent

The dye ink composition according to the present invention may include a chelating agent.

A chelating agent is a compound that bonds to an inorganic or metal cation (particularly preferably, polyvalent cation) to form a chelate compound.

In the present invention, a chelating agent reduces the formation and growth of insoluble foreign matter that is derived from the inorganic or metal cation (in particular, polyvalent cation) and that precipitates in the coloring composition (i.e., serves as a solubilizing agent).

Since the coloring composition according to the present invention includes the chelating agent, the precipitation of the foreign matter can be reduced even in the case where the coloring composition is stored over a long period of time. In the case where images are printed using an ink jet printer with an ink for ink jet recording that includes an aqueous ink composition that has been stored over a long period of time, the likelihood of the nozzles and the like being clogged with the ink is low and high-quality printed materials can be produced. The chelating agent that can be used in the present invention is not limited; various chelating agents can be used.

Since the type of the ink for ink jet recording is shifting from a cartridge ink to an ink for large-capacity ink tanks, there is a demand for further improvement of long-term storage stability (the print quality and ejection stability of the ink that has been stored over a long period of time). Since the coloring composition according to the present invention includes the chelating agent, the long-term storage stability can be further enhanced.

As a chelating agent, any solubilizing agents that combine with a cation present in the coloring composition to form a complex due to a chelation effect and thereby reduce the formation and growth of the foreign matter that precipitates in the aqueous ink composition can be used alone or in combination of two or more. The chelating agent is preferably a water-soluble compound.

Examples of the chelating agent include ethylenediaminetetraacetic acid (EDTA) or a salt thereof (e.g., EDTA-4 sodium (4 sodium salt) or EDTA-4 lithium (4 lithium salt)); picolinic acid or a salt thereof (e.g., sodium picolinate); quinolinic acid or a salt thereof (e.g., sodium quinolinate); 1,10-phenanthroline, 8-hydroxyquinoline, 3-hydroxy-2,2′-iminodisuccinic acid 4 sodium, and methylglycine 2 acetic acid (MGDA) or a salt thereof; L-glutamic acid 2 acetic acid (GLDA) or a salt thereof; L-aspartic acid 2 acetic acid (ASDA) or a salt thereof; hydroxyethyliminodiacetic acid (HIDA) or a salt thereof; 3-hydroxy-2,2′-iminodisuccinic acid (HIDS) or a salt thereof; dicarboxymethyl glutamic acid (CMGA) or a salt thereof; and (S,S)-ethylenediamine disuccinic acid (EDDS) or a salt thereof. Among the above chelating agents, the salts are preferably, for example, salts of monovalent metals, such as sodium, potassium, and lithium; or salts of ammonium and amine. Among the above chelating agents, reductions in the chelation effects of these salts with a change in the pH of the coloring composition are smaller. Therefore, these salts can produce the chelation effects in a wide pH range and are capable of addressing, for example, a change in the pH of the coloring composition, which may occur over time, in a further suitable manner.

The content of the chelating agent is preferably 0.001% by mass or more and 1.1% by mass or less, is more preferably 0.001% by mass or more and 0.5% by mass or less, is further preferably 0.001% by mass or more and 0.3% by mass or less, and is particularly preferably 0.001% by mass or more and 0.1% by mass or less, relative to the total mass of the coloring composition. When the above content is 0.001% by mass or more, the chelation effect can be produced with effect. When the above content is 1.1% by mass or less, the possibility of the viscosity and pH of the coloring composition being excessively increased due to the addition of the chelating agent can be reduced.

The proportions of the chelating agent and the colorant in the coloring composition (Content of the chelating agent by mass:Content of the colorant by mass) is preferably 0.0001:1 to 0.15:1 (i.e., Chelating agent/Colorant is preferably 0.0001 to 0.15), is more preferably 0.0001:1 to 0.01:1, and is further preferably 0.0002:1 to 0.005:1.

The metal that can be form a metal salt is a metal that may enter to a dye in the process for producing the dye or a metal that is included in a container accommodating an ink including the coloring composition and that may elute to the coloring composition. When the above ratio falls within the above range, the formation of foreign matter that may cause clogging of ink jet heads can be reduced with effect. Furthermore, the chelation effect can be produced with effect. This reduces the possibility of the viscosity and pH of the dye ink composition being excessively increased.

The coloring composition according to the present invention can be used for producing, for example, an image recording material for image formation. Specific examples thereof include the ink jet-system recording material described in detail below, a thermal recording material, a pressure-sensitive recording material, a recording material that uses an electrophotographic system, a transfer-system silver halide photosensitive material, a printing ink, and a recording pen. Among these, an ink jet-system recording material, a thermal recording material, and a recording material that uses an electrophotographic system are preferable, and an ink jet-system recording material is further preferable.

The coloring composition according to the present invention can also be used for producing color filters used for recording and reproducing color images, which are included in solid-state imaging elements, such as charge-coupled devices (CCDs), and displays, such as liquid crystal displays (LCDs) and plasma display panels (PDPs), and for producing stains used for coloring fibers.

The aqueous medium can be a mixture that includes water as a principal constituent and, as needed, a water-miscible organic solvent. Examples of the water-miscible organic solvent include alcohols (e.g., methanol, ethanol, propanol, isopropanol, butanol, isobutanol, sec-butanol, t-butanol, pentanol, hexanol, cyclohexanol, and benzyl alcohol), polyhydric alcohols (e.g., ethylene glycol, diethylene glycol, triethylene glycol, polyethylene glycol, propylene glycol, dipropylene glycol, polypropylene glycol, butylene glycol, hexanediol, pentanediol, glycerin, hexanetriol, and thiodiglycol), glycol derivatives (e.g., ethylene glycol monomethyl ether, ethylene glycol monoethyl ether, ethylene glycol monobutyl ether, diethylene glycol monomethyl ether, diethylene glycol monobutyl ether, propylene glycol monomethyl ether, propylene glycol monobutyl ether, dipropylene glycol monomethyl ether, triethylene glycol monomethyl ether, ethylene glycol diacetate, ethylene glycol monomethyl ether acetate, triethylene glycol monomethyl ether, triethylene glycol monoethyl ether, and ethylene glycol monophenyl ether), amines (e.g., ethanolamine, diethanolamine, triethanolamine, N-methyldiethanolamine, N-ethyldiethanolamine, morpholine, N-ethylmorpholine, ethylenediamine, diethylenetriamine, triethylenetetramine, polyethyleneimine, and tetramethylpropylenediamine), and other polar solvents (e.g., formamide, N,N-dimethylformamide, N,N-dimethylacetamide, dimethylsulfoxide, sulfolane, 2-pyrrolidone, N-methyl-2-pyrrolidone, N-vinyl-2-pyrrolidone, 2-oxazolidone, 1,3-dimethyl-2-imidazolidinone, acetonitrile, and acetone). The above water-miscible organic solvents may be used in combination of two or more.

The viscosity of the ink for ink jet recording according to the present invention is preferably 30 mPa·s or less. The surface tension of the ink for ink jet recording is preferably 25 mN/m or more and 70 mN/m or less. The viscosity and surface tension of the ink can be adjusted by addition of various additives, such as a viscosity modifier, a surface tension modifier, a specific resistance modifier, a coating-film modifier, an ultraviolet absorber, an antioxidant, an antifade agent, an antifungal agent, an anticorrosive, a dispersing agent, and a surfactant.

The ink for ink jet recording according to the present invention can be any of the inks having various color tones and is preferably an ink having a magenta color tone. The ink for ink jet recording can be used for forming not only monochromatic images but also full-color images. In order to form full-color images, an ink having a magenta color tone, an ink having a cyan color tone, and an ink having a yellow color tone can be used. An ink having a black color tone may be further used to adjust a color tone.

The ink for ink jet recording according to the present invention can be used in recording methods, such as printing, copying, marking, writing, drawing, and stamping, and is particularly suitably used in an ink jet recording method.

### Ink Jet Recording Method

In an ink jet recording method according to the present invention, energy is applied to the ink for ink jet recording according to the present invention and, thereby, an image is formed on a common image-receiving material known in the related art, that is, for example, a plain paper sheet, a resin-coated paper sheet, an ink jet paper sheet described in, for example, JP1996-169172A (JP-H8-169172A), JP1996-27693A (JP-H8-27693A), JP1990-276670A (JP-H2-276670A), JP1995-276789A (JP-H7-276789A), JP1997-323475A (JP-H9-323475A), JP1987-238783A (JP-S62-238783A), JP1998-153989A (JP-H10-153989A), JP1998-217473A (JP-H10-217473A), JP1998-235995A (JP-H10-235995A), JP1998-337947A (JP-H10-337947A), JP1998-217597A (JP-H10-217597A), or JP1998-337947A (JP-H10-337947A), a film, an electrophotographic common paper sheet, a fabric, a glass material, a metal, or a ceramic.

In the formation of images, a polymer microparticle dispersion (i.e., polymer latex) may also be used to impart glossiness and water resistance and improve weather resistance. The polymer latex may be added to the image-receiving material before, after, or simultaneously with the application of the colorant. Thus, the polymer latex may be added to either an image-receiving paper sheet or the ink. In another case, the polymer latex may be used alone in the form of a liquid. Specifically, the methods described in the specifications of, for example, JP2000-363090, JP2000-315231, JP2000-354380, JP2000-343944, JP2000-268952, JP2000-299465, and JP2000-297365 can be preferably used.

### Ink Jet Printer Cartridge and Ink Jet-Recorded Matter

An ink cartridge for ink jet recording according to the present invention includes the above-described ink for ink jet recording according to the present invention. The ink jet-recorded matter is produced by forming a color image on a recording material using the above-described ink for ink jet recording according to the present invention.

The ink jet recording system in which the ink for ink jet recording according to the present invention is used is not limited. The ink for ink jet recording can be used in common recording systems known in the related art, such as a charge control-type recording system in which an ink is ejected using an electrostatic attractive force, a drop-on-demand-type (pressure pulse-type) recording system in which the pressure caused by the vibration of a piezoelectric element is used, an acoustic ink jet recording system in which an electrical signal is converted into an acoustic beam, with which an ink is irradiated, and the ink is ejected using the resulting radiation pressure, and a thermal ink jet recording system in which an ink is heated to form bubbles and the resulting pressure is utilized. Examples of the ink jet recording system include a recording system in which a number of droplets of an ink having a low concentration, which is referred to as “photo ink”, are ejected in small volumes; a recording system in which a plurality of inks having substantially the same hue and different concentrations are used to improve image quality; and a recording system in which a colorless, transparent ink is used.

### EXAMPLES

The present invention is described in detail with reference to Examples below. The present invention is not limited by Examples below. In Examples, “%” and “part” refer to “% by mass” and “part by mass”, respectively, unless otherwise specified.

The compounds represented by General Formula (1) which were used in Examples and Comparative Examples were synthesized by common synthesis methods known in the related art (e.g., the method described in Paragraphs [0150] to [0165] of WO2018/062044A).

### Example 1

In 200.00 parts by mass of deionized water, 22.50 parts by mass of the compound (1-11) described above, 2.50 parts by mass of the compound (d-1-Na) described above, 1.1 parts by mass of an antiseptic agent, and 0.30 parts by mass of a buffering agent (NaHCO₃) were dissolved. The pH of the resulting solution was adjusted to be 8.0 with a 10-mol/L aqueous sodium hydroxide solution. The solution was then filtered through a microfilter having an average pore size of 0.20 μm under reduced pressure and subsequently washed with deionized water. Hereby, 250.00 parts by mass of a concentrated dye ink (liquid A) was prepared.

In 50.00 parts by mass of deionized water, 10.00 parts by mass of glycerin, 2.00 parts by mass of triethylene glycol, 10.00 parts by mass of triethylene glycol monobutyl ether, 2.00 parts by mass of 2-pyrrolidone, and 1.00 parts by mass of a surfactant were dissolved. Hereby, an ink composition base liquid (liquid B) was prepared.

With 25.00 parts by mass of the liquid A, the whole amount of the liquid B was mixed at a temperature of 30° C. to 40° C. The resulting liquid mixture was stirred at a temperature of 30° C. to 40° C. for 1 hour. Subsequently, the internal temperature was reduced to 25° C. Then, the pH of the liquid mixture was adjusted to be 8.5 with a 10-mol/L aqueous sodium hydroxide solution. Subsequently, the liquid mixture was filtered through a microfilter having an average pore size of 0.20 μm under reduced pressure. Deionized water was added to the filtrate. Hereby, a magenta ink 1 for ink jet recording (100.00 parts by mass) was prepared.

The antiseptic agent used was “PROXEL (registered trademark) XL2(s)” produced by LONZA.

The surfactant used was “Surfynol (registered trademark) 465” produced by Nissin Chemical Industry Co., Ltd.

The compound (1-11) is a compound represented by General Formula (1). The compound (d-1-Na) is a compound represented by General Formula (D).

Table 1 lists the composition of the ink 1 for ink jet recording. In Table 1, the amounts of constituents are expressed in units of part by mass.

### Examples 2 to 10

Inks 2 to 10 for ink jet recording were prepared as in Example 1, except that the types and amounts (parts by mass) of the constituents used were changed as described in Table 1 below. Note that, in Examples in which the betaine-1 or -2 below was used, the betaine-1 or -2 was added to the liquid A described above in the preparation of the ink for ink jet recording. The buffering agent, antiseptic agent, and surfactant used were the same as those used in Example 1.

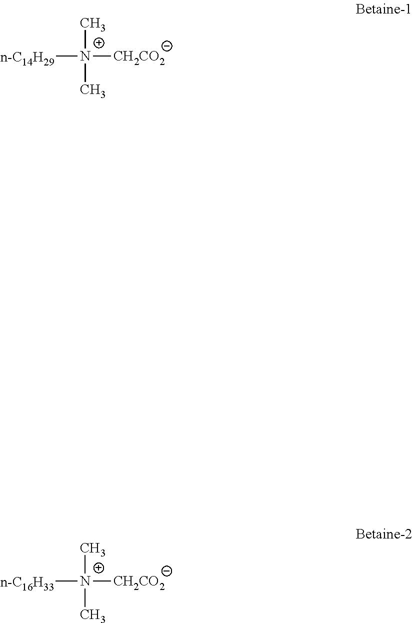

TABLE 1

| | Example | Example | Example | Example | Example | Example | Example | Example | Example | Example |
|---|---|---|---|---|---|---|---|---|---|---|
| | 1 | 2 | 3 | 4 | 5 | 6 | 7 | 8 | 9 | 10 |
| (1-11) | 2.25 | 2.25 | 2.25 | 2.00 | 1.75 | 1.65 | 1.25 | 2.40 | 2.00 | 1.50 |
| (d-1-Na) | 0.25 | 0.25 | 0.25 | 0.50 | 0.75 | 0.35 | 1.25 | 0.60 | 1.00 | 1.50 |
| Antiseptic | 0.11 | 0.11 | 0.11 | 0.11 | 0.11 | 0.11 | 0.11 | 0.11 | 0.11 | 0.11 |
| agent | | | | | | | | | | |
| Betaine-1 | 0.00 | 1.28 | 0.00 | 1.14 | 1.00 | 1.00 | 1.00 | 1.00 | 1.00 | 1.00 |
| Betaine-2 | 0.00 | 0.00 | 1.28 | 0.00 | 0.00 | 0.00 | 0.00 | 0.00 | 0.00 | 0.00 |
| Glycerin | 10.00 | 10.00 | 10.00 | 10.00 | 10.00 | 10.00 | 10.00 | 10.00 | 10.00 | 10.00 |
| Triethylene | 2.00 | 2.00 | 2.00 | 2.00 | 2.00 | 2.00 | 2.00 | 2.00 | 2.00 | 2.00 |
| glycol | | | | | | | | | | |
| Triethylene | 10.00 | 10.00 | 10.00 | 10.00 | 10.00 | 10.00 | 10.00 | 10.00 | 10.00 | 10.00 |
| glycol | | | | | | | | | | |
| monobutyl | | | | | | | | | | |
| ether | | | | | | | | | | |
| 2-Pyrrolidone | 2.00 | 2.00 | 2.00 | 2.00 | 2.00 | 2.00 | 2.00 | 2.00 | 2.00 | 2.00 |
| Surfactant | 1.00 | 1.00 | 1.00 | 1.00 | 1.00 | 1.00 | 1.00 | 1.00 | 1.00 | 1.00 |
| Buffering | 0.03 | 0.03 | 0.03 | 0.03 | 0.03 | 0.03 | 0.03 | 0.03 | 0.03 | 0.03 |
| agent | | | | | | | | | | |
| Deionized | 72.36 | 71.08 | 71.08 | 71.22 | 71.36 | 71.86 | 71.36 | 70.86 | 70.86 | 70.86 |
| water | | | | | | | | | | |
| Total | 100.00 | 100.00 | 100.00 | 100.00 | 100.00 | 100.00 | 100.00 | 100.00 | 100.00 | 100.00 |

Unit: part by mass

### Examples 11 to 22

Inks 11 to 22 for ink jet recording were prepared as in Example 1, except that the types and amounts (parts by mass) of the constituents used were changed as described in Table 2 below. Note that, in Examples in which the betaine-1 was used, the betaine-1 was added to the liquid A described above in the preparation of the ink for ink jet recording. The buffering agent, antiseptic agent, and surfactant used were the same as those used in Example 1.

TABLE 2

| | | Exam- | Exam- | Exam- | Exam- | Exam- | Exam- | Exam- | Exam- | Exam- | Exam- | Exam- | Exam- |
|---|---|---|---|---|---|---|---|---|---|---|---|---|---|
| | | ple 11 | ple 12 | ple 13 | ple 14 | ple 15 | ple 16 | ple 17 | ple 18 | ple 19 | ple 20 | ple 21 | ple 22 |
| Compound | Type | (1-18) | (1-19) | (1-20) | (1-25) | (1-26) | (1-26) | (1-29) | (1-30) | (1-30) | (1-34) | (1-35) | (1-35) |
| represented | Amount | 2.25 | 2.25 | 2.25 | 2.25 | 2.25 | 2.25 | 2.25 | 2.25 | 2.25 | 2.25 | 2.25 | 2.25 |
| by General | | | | | | | | | | | | | |
| Formula (1) | | | | | | | | | | | | | |

| | | | | | | | | | | | | |
|---|---|---|---|---|---|---|---|---|---|---|---|---|
| (d-1-Na) | 0.25 | 0.25 | 0.25 | 0.25 | 0.25 | 0.25 | 0.25 | 0.25 | 0.25 | 0.25 | 0.25 | 0.25 |
| Antiseptic agent | 0.11 | 0.11 | 0.11 | 0.11 | 0.11 | 0.11 | 0.11 | 0.11 | 0.11 | 0.11 | 0.11 | 0.11 |
| Betaine-1 | 1.28 | 1.28 | 1.28 | 1.28 | 0.00 | 1.28 | 1.28 | 0.00 | 1.28 | 1.28 | 0.00 | 1.28 |
| Glycerin | 10.00 | 10.00 | 10.00 | 10.00 | 10.00 | 10.00 | 10.00 | 10.00 | 10.00 | 10.00 | 10.00 | 10.00 |
| Triethylene glycol | 2.00 | 2.00 | 2.00 | 2.00 | 2.00 | 2.00 | 2.00 | 2.00 | 2.00 | 2.00 | 2.00 | 2.00 |
| Triethylene glycol | 10.00 | 10.00 | 10.00 | 10.00 | 10.00 | 10.00 | 10.00 | 10.00 | 10.00 | 10.00 | 10.00 | 10.00 |
| monobutyl ether | | | | | | | | | | | | |
| 2-Pyrrolidone | 2.00 | 2.00 | 2.00 | 2.00 | 2.00 | 2.00 | 2.00 | 2.00 | 2.00 | 2.00 | 2.00 | 2.00 |
| Surfactant | 1.00 | 1.00 | 1.00 | 1.00 | 1.00 | 1.00 | 1.00 | 1.00 | 1.00 | 1.00 | 1.00 | 1.00 |
| Buffering agent | 0.03 | 0.03 | 0.03 | 0.03 | 0.03 | 0.03 | 0.03 | 0.03 | 0.03 | 0.03 | 0.03 | 0.03 |
| Deionized water | 71.08 | 71.08 | 71.08 | 71.08 | 72.36 | 71.08 | 71.08 | 72.36 | 71.08 | 71.08 | 72.36 | 71.08 |
| Total | 100.00 | 100.00 | 100.00 | 100.00 | 100.00 | 100.00 | 100.00 | 100.00 | 100.00 | 100.00 | 100.00 | 100.00 |

Unit: part by mass

### Examples 23 to 27

Inks 23 to 27 for ink jet recording were prepared as in Example 1, except that the types and amounts (parts by mass) of the constituents used were changed as described in Table 3 below. Note that, in Examples in which the betaine-1 was used, the betaine-1 was added to the liquid A described above in the preparation of the ink for ink jet recording. The buffering agent, antiseptic agent, and surfactant used were the same as those used in Example 1.

TABLE 3

| | | Example 23 | Example 24 | Example 25 | Example 26 | Example 27 |
|---|---|---|---|---|---|---|
| (1-11) | | 2.25 | 2.25 | 2.25 | 2.25 | 2.25 |
| Compound | Type | (d-2-Na) | (d-2-Na) | (d-3-Na) | (d-4-Na) | (d-5-Na) |
| represented by | Amount | 0.25 | 0.25 | 0.25 | 0.25 | 0.25 |
| General Formula | | | | | | |
| (D) | | | | | | |

| | | | | | |
|---|---|---|---|---|---|
| Antiseptic agent | 0.11 | 0.11 | 0.11 | 0.11 | 0.11 |
| Betaine-1 | 0.00 | 1.28 | 1.28 | 1.28 | 1.28 |
| Glycerin | 10.00 | 10.00 | 10.00 | 10.00 | 10.00 |
| Triethylene glycol | 2.00 | 2.00 | 2.00 | 2.00 | 2.00 |
| Triethylene glycol | 10.00 | 10.00 | 10.00 | 10.00 | 10.00 |
| monobutyl ether | | | | | |
| 2-Pyrrolidone | 2.00 | 2.00 | 2.00 | 2.00 | 2.00 |
| Surfactant | 1.00 | 1.00 | 1.00 | 1.00 | 1.00 |
| Buffering agent | 0.03 | 0.03 | 0.03 | 0.03 | 0.03 |
| Deionized water | 72.36 | 71.08 | 71.08 | 71.08 | 71.08 |
| Total | 100.00 | 100.00 | 100.00 | 100.00 | 100.00 |

Unit: part by mass

The structures of the compounds represented by General Formula (D) which are listed in Table 3 are illustrated below.

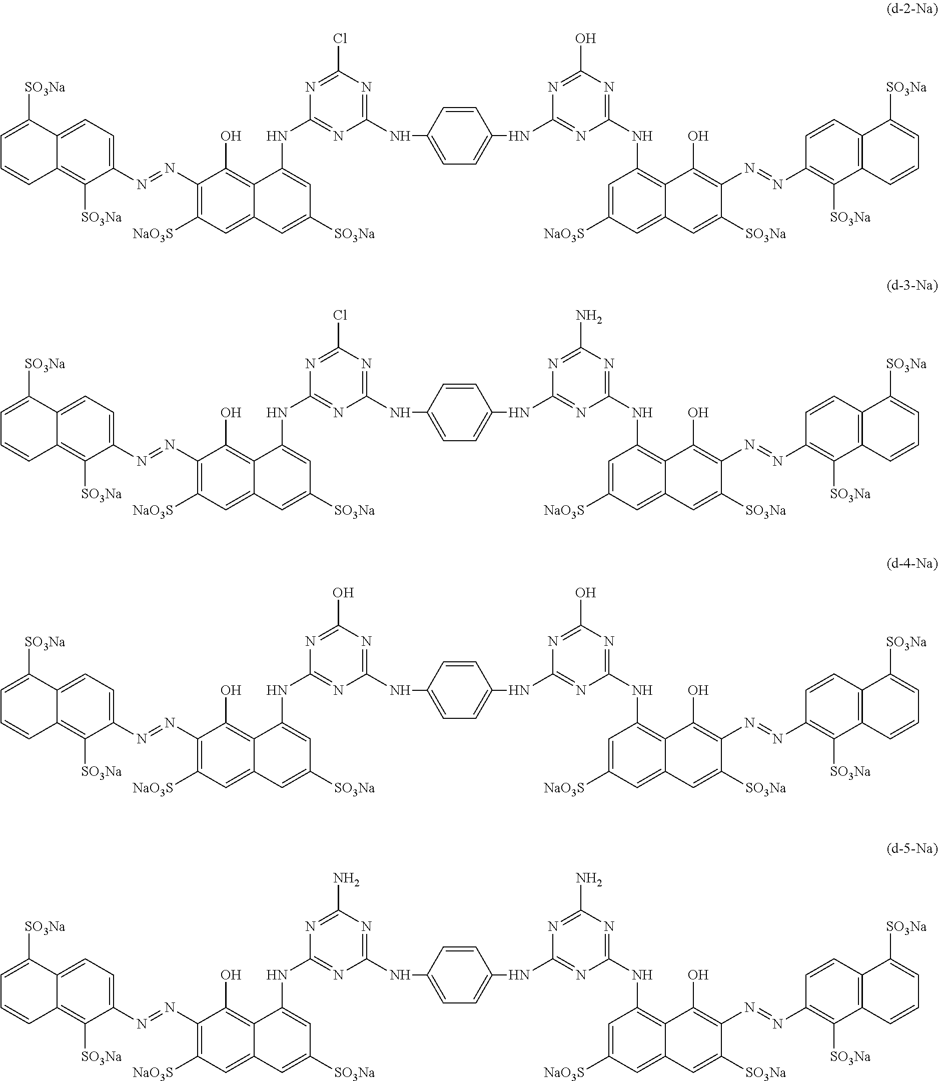

### Example 28

In 200.00 parts by mass of deionized water, 22.50 parts by mass of the compound (1-26) described above, 2.50 parts by mass of the compound (d-3-Na) described above, 1.1 parts by mass of an antiseptic agent, and 0.30 parts by mass of a buffering agent (NaHCO₃) were dissolved. The pH of the resulting solution was adjusted to be 8.0 with a 10-mol/L aqueous sodium hydroxide solution. The solution was then filtered through a microfilter having an average pore size of 0.20 μm under reduced pressure and subsequently washed with deionized water. Hereby, 250.00 parts by mass of a concentrated dye ink (liquid C) was prepared.

In 50.00 parts by mass of deionized water, 7.00 parts by mass of glycerin, 7.00 parts by mass of ethylene urea, 7.00 parts by mass of 1,5-pentanediol, 5.00 parts by mass of 2-pyrrolidone, and 0.50 parts by mass of a surfactant were dissolved. Hereby, an ink composition base liquid (liquid D) was prepared.

With 25.00 parts by mass of the liquid C, the whole amount of the liquid D was mixed at a temperature of 30° C. to 40° C. The resulting liquid mixture was stirred at a temperature of 30° C. to 40° C. for 1 hour. Subsequently, the internal temperature was reduced to 25° C. Then, the pH of the liquid mixture was adjusted to be 8.5 with a 10-mol/L aqueous sodium hydroxide solution. Subsequently, the liquid mixture was filtered through a microfilter having an average pore size of 0.20 μm under reduced pressure. Deionized water was added to the filtrate. Hereby, a magenta ink 28 for ink jet recording (100.00 parts by mass) was prepared.

The buffering agent, antiseptic agent, and surfactant used were the same as those used in Example 1.

Table 4 lists the composition of the ink 28 for ink jet recording. In Table 4, the amounts of constituents are expressed in units of part by mass.

### Examples 29 to 32

Inks 29 to 32 for ink jet recording were prepared as in Example 28, except that the types and amounts (parts by mass) of the constituents used were changed as described in Table 4 below. The buffering agent, antiseptic agent, and surfactant used were the same as those used in Example 1.

TABLE 4

| | | Example 28 | Example 29 | Example 30 | Example 31 | Example 32 |
|---|---|---|---|---|---|---|
| Compound | Type | (1-26) | (1-30) | (1-26) | (1-30) | (1-30) |
| represented by | Amount | 2.25 | 2.25 | 2.00 | 2.00 | 1.50 |
| General Formula | | | | | | |
| (1) | | | | | | |

| | | | | | |
|---|---|---|---|---|---|
| (d-3-Na) | 0.25 | 0.25 | 1.00 | 1.00 | 1.50 |
| Antiseptic agent | 0.11 | 0.11 | 0.11 | 0.11 | 0.11 |
| Glycerin | 7.00 | 7.00 | 7.00 | 7.00 | 7.00 |
| Ethylene urea | 7.00 | 7.00 | 7.00 | 7.00 | 7.00 |
| 1,5-Pentanediol | 7.00 | 7.00 | 7.00 | 7.00 | 7.00 |
| 2-Pyrrolidone | 5.00 | 5.00 | 5.00 | 5.00 | 5.00 |
| Surfactant | 0.50 | 0.50 | 0.50 | 0.50 | 0.50 |
| Buffering agent | 0.03 | 0.03 | 0.03 | 0.03 | 0.03 |
| Deionized water | 70.86 | 70.86 | 70.36 | 70.36 | 70.36 |
| Total | 100.00 | 100.00 | 100.00 | 100.00 | 100.00 |

Unit: part by mass

### Example 33

An ink 33 for ink jet recording was prepared as in Example 30, except that the compound (1-33) described above was used as a compound represented by General Formula (1) instead of the compound (1-26), the compound (d-3-Li) described above was used as a compound represented by General Formula (D) instead of the compound (d-3-Na), and a 10-mol/L aqueous lithium hydroxide solution was used instead of the 10-mol/L aqueous sodium hydroxide solution.

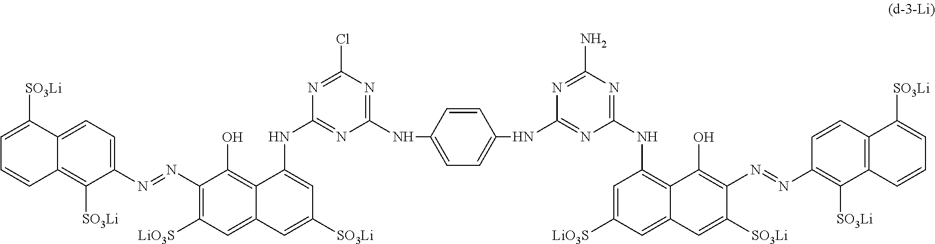

### Example 34

An ink 34 for ink jet recording was prepared as in Example 30, except that the compound (1-35) described above was used as a compound represented by General Formula (1) instead of the compound (1-26), the compound (d-3-K) described above was used as a compound represented by General Formula (D) instead of the compound (d-3-Na), and a 10-mol/L aqueous potassium hydroxide solution was used instead of the 10-mol/L aqueous sodium hydroxide solution.

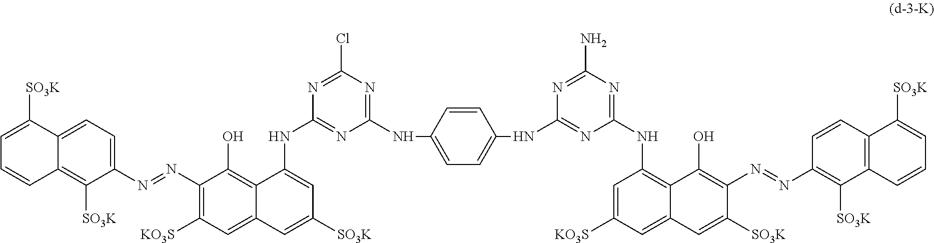

### Comparative Examples 1 to 6

Comparative inks R1 to R6 for ink jet recording were prepared as in Example 1, except that the types and amounts (parts by mass) of the constituents used were changed as described in Table 5 below. Note that, in Comparative Examples in which the betaine-1 or -2 was used, the betaine-1 or -2 was added to the liquid A described above in the preparation of the comparative ink for ink jet recording. The buffering agent, antiseptic agent, and surfactant used were the same as those used in Example 1.

TABLE 5

| | Comparative | Comparative | Comparative | Comparative | Comparative | Comparative |
|---|---|---|---|---|---|---|
| | example 1 | example 2 | example 3 | example 4 | example 5 | example 6 |
| (1-11) | 0.00 | 0.00 | 2.50 | 0.87 | 0.75 | 1.20 |
| (d-1-Na) | 2.50 | 2.50 | 0.00 | 1.63 | 1.75 | 1.80 |
| Antiseptic | 0.11 | 0.11 | 0.11 | 0.11 | 0.11 | 0.11 |
| agent | | | | | | |
| Betaine-1 | 0.00 | 1.43 | 0.00 | 0.00 | 0.00 | 0.00 |
| Betaine-2 | 0.00 | 0.00 | 0.00 | 0.00 | 0.00 | 0.00 |
| Glycerin | 10.00 | 10.00 | 10.00 | 10.00 | 10.00 | 10.00 |
| Triethylene | 2.00 | 2.00 | 2.00 | 2.00 | 2.00 | 2.00 |
| glycol | | | | | | |
| Triethylene | 10.00 | 10.00 | 10.00 | 10.00 | 10.00 | 10.00 |
| glycol | | | | | | |
| monobutyl | | | | | | |
| ether | | | | | | |
| 2-Pyrrolidone | 2.00 | 2.00 | 2.00 | 2.00 | 2.00 | 2.00 |
| Surfactant | 1.00 | 1.00 | 1.00 | 1.00 | 1.00 | 1.00 |
| Buffering | 0.03 | 0.03 | 0.03 | 0.03 | 0.03 | 0.03 |
| agent | | | | | | |
| Deionized | 72.36 | 70.93 | 72.36 | 72.36 | 72.36 | 71.86 |
| water | | | | | | |
| Total | 100.00 | 100.00 | 100.00 | 100.00 | 100.00 | 100.00 |

Unit: part by mass

### Comparative Examples 7 to 11

Comparative inks R7 to R11 for ink jet recording were prepared as in Example 1, except that the comparative compounds listed in Table 6 below were used instead of the compound (1-11) and the types and amounts (parts by mass) of the constituents used were changed as described in Table 6 below. The buffering agent, antiseptic agent, and surfactant used were the same as those used in Example 1.

TABLE 6

| | | Comparative | Comparative | Comparative | Comparative | Comparative |
|---|---|---|---|---|---|---|
| | | example 7 | example 8 | example 9 | example 10 | example 11 |
| Comparative | Type | (Comparative | (Comparative | (Comparative | (Comparative | (Comparative |
| compound | | compound 1) | compound 2) | compound 3) | compound 4) | compound 5) |
| | Amount | 2.00 | 2.00 | 2.00 | 2.00 | 2.00 |

| | | | | | |
|---|---|---|---|---|---|
| (d-1-Na) | 0.50 | 0.50 | 0.50 | 0.50 | 0.50 |
| Antiseptic agent | 0.11 | 0.11 | 0.11 | 0.11 | 0.11 |
| Glycerin | 10.00 | 10.00 | 10.00 | 10.00 | 10.00 |
| Triethylene glycol | 2.00 | 2.00 | 2.00 | 2.00 | 2.00 |
| Triethylene glycol | 10.00 | 10.00 | 10.00 | 10.00 | 10.00 |
| monobutyl ether | | | | | |
| 2-Pyrrolidone | 2.00 | 2.00 | 2.00 | 2.00 | 2.00 |
| Surfactant | 1.00 | 1.00 | 1.00 | 1.00 | 1.00 |
| Buffering agent | 0.03 | 0.03 | 0.03 | 0.03 | 0.03 |
| Deionized water | 72.36 | 72.36 | 72.36 | 72.36 | 72.36 |
| Total | 100.00 | 100.00 | 100.00 | 100.00 | 100.00 |

Unit: part by mass

The structures of the comparative compounds used in Comparative Examples 7 to 11 are illustrated below.

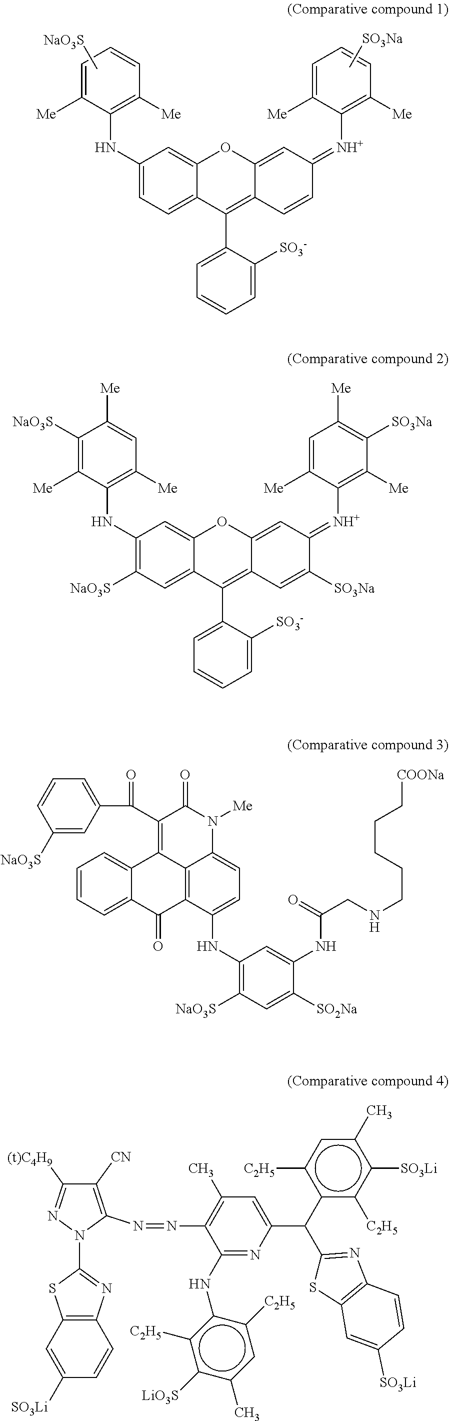

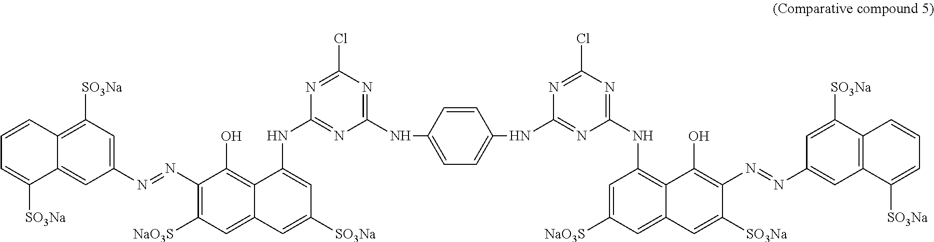

### Comparative Example 12

A comparative ink R12 for ink jet recording was prepared as in Example 1, except that the comparative compound 5 was used instead of the compound (d-1-Na).

### Comparative Examples 13 to 17

Comparative inks R13 to R17 for ink jet recording were prepared as in Example 28, except that the types and amounts (parts by mass) of the constituents used were changed as described in Table 7 below. The buffering agent, antiseptic agent, and surfactant used were the same as those used in Example 28.

TABLE 7

| | | Comparative | Comparative | Comparative | Comparative | Comparative |
|---|---|---|---|---|---|---|
| | | example 13 | example 14 | example 15 | example 16 | example 17 |
| Compound | Type | None | (1-26) | (1-30) | (1-26) | (1-30) |
| represented | Amount | 0.00 | 1.00 | 1.00 | 1.00 | 1.00 |
| by General | | | | | | |
| Formula (1) | | | | | | |

| | | | | | |
|---|---|---|---|---|---|
| (d-1-Na) | 2.50 | 0.00 | 0.00 | 1.50 | 1.50 |
| Antiseptic agent | 0.11 | 0.11 | 0.11 | 0.11 | 0.11 |
| Glycerin | 7.00 | 7.00 | 7.00 | 7.00 | 7.00 |
| Ethylene urea | 7.00 | 7.00 | 7.00 | 7.00 | 7.00 |
| 1,5-Pentanediol | 7.00 | 7.00 | 7.00 | 7.00 | 7.00 |
| 2-Pyrrolidone | 5.00 | 5.00 | 5.00 | 5.00 | 5.00 |
| Surfactant | 0.50 | 0.50 | 0.50 | 0.50 | 0.50 |
| Buffering agent | 0.03 | 0.03 | 0.03 | 0.03 | 0.03 |
| Deionized water | 70.86 | 72.36 | 72.36 | 70.86 | 70.86 |
| Total | 100.00 | 100.00 | 100.00 | 100.00 | 100.00 |

Unit: part by mass

### Comparative Example 18

A comparative ink R18 for ink jet recording was prepared as in Example 28, except that the compound (1-11) was used instead of the compound (1-26) and the comparative compound 5 was used instead of the compound (d-3-Na).

### Image Recording and Evaluations

The inks 1 to 34 for ink jet recording prepared in Examples and the comparative inks R1 to R18 for ink jet recording were evaluated in terms of the following items.

As for the inks 1 to 27 for ink jet recording prepared in Examples 1 to 27 and the comparative inks R1 to R12 for ink jet recording prepared in Comparative Examples 1 to 12, each of the inks for ink jet recording was charged into an ink cartridge, an image was recorded on a photo paper sheet (photo paper <glossy> produced by Seiko Epson Corporation) with an ink jet printer (“PM-700C” produced by Seiko Epson Corporation), and the image was evaluated.

As for the inks 28 to 34 for ink jet recording prepared in Examples 28 to 34 and the comparative inks R13 to R18 for ink jet recording prepared in Comparative Examples 13 to 18, each of the inks for ink jet recording was charged into an ink cartridge, an image was recorded on an ink jet paper sheet (glossy photo paper “PT-201” produced by CANON INC.) with an ink jet printer (“PIXUS Pro9000MkII” produced by CANON INC.), and the image was evaluated.

Hue

The printed sample was visually inspected and evaluated on the three-point scale below.

A: Pure magenta

B: Slightly reddish magenta (close to red)

C: Clearly reddish violet

Chroma

The chroma (C*) of the printed material was calculated using the following formula on the basis of measurement of chromatic characteristics. The lightness L* and chromaticity a* and b* of a printed image portion in the CIE L*a*b* colorimetric system (The International Commission on Illumination Standard (1976) or JIS Standard Z8781-4: 2013) were measured with a reflection densitometer (product name: X-Rite 310TR, produced by X-Rite, Inc.) at an applied voltage of 50%. The chroma (C*) was calculated on the basis of the measured values using the computation formula below and evaluated. The evaluation was made in accordance with the following evaluation criteria.

Chroma (C*)=(a*²+b*²)^{1/2}

A: C* was 90 or more

B: C* was 80 or more and less than 90

C: C* was less than 80

Print Density

A monochromatic image pattern in which image density was changed in a stepwise manner such that the optical density (OD) value of magenta color varied in the range of 0.1 to 2.0 was printed on a photo paper sheet. The reflection density (image density) which corresponded to the print density (ODmax) was measured using a reflection densitometer (X-Rite 310TR). Then, an evaluation was made on the four-point scale below.

A: The print density was 2.0 or more

B: The print density was 1.8 or more and less than 2.0

C: The print density was 1.7 or more and less than 1.8

D: The print density was less than 1.7

Light Resistance

The density Ci of the image was measured immediately after the image had been recorded. Subsequently, the image was irradiated with xenon (100,000 lux) for 28 days using a weather meter (Atlas C. 165) at 23° C. and a relative humidity of 50% with an ultraviolet cut filter L37 (produced by FUJIFILM Corporation). Then, the density Cf1 of the image was again measured. A colorant residual ratio was calculated on the basis of the image densities measured before and after the image had been irradiated with xenon light and evaluated. The image densities were measured with a reflection densitometer (product name: X-Rite 310TR, produced by X-Rite, Inc.). The colorant residual ratio was measured using a portion of the image in which the initial image density was 1.0±0.2.

The colorant residual ratio was calculated using the following formula and evaluated in accordance with the following evaluation criteria.

Colorant residual ratio (%)=(Cfl/Ci)×100

A: The colorant residual ratio was 90% or more and less than 95%

B: The colorant residual ratio was 80% or more and less than 90%

C: The colorant residual ratio was less than 80%

Ozone Resistance

While dry air was passed through a double glass pipe of a Siemens ozonizer, an alternating voltage of 5 kV was applied. Using this equipment, a box that had an ozone gas concentration of 5±0.1 parts per million (ppm), a temperature of 23° C., and a relative humidity of 50% and that was set to be a dark place was prepared. In this box, the glossy photo paper sheet on which the image was formed was left to stand for 3 days. The density of the image that had been left to stand in the ozone gas was measured with a reflection densitometer (product name: X-Rite 310TR, produced by X-Rite, Inc.). A colorant residual ratio was calculated on the basis of the initial image density Ci and the density Cf2 of the image that had been left to stand in the ozone gas and evaluated. The colorant residual ratio was measured using a portion of the image in which the initial image density was 1.0±0.2. The ozone gas concentration in the box was set using an ozone gas monitor (model: OZG-EM-01) produced by APPLICS.

The colorant residual ratio was calculated using the following formula and evaluated in accordance with the following evaluation criteria.

Colorant residual ratio (%)=(Cf2/Ci)×100

A: The colorant residual ratio was 85% or more and less than 90%

B: The colorant residual ratio was 80% or more and less than 85%

C: The colorant residual ratio was less than 80%

Moisture Resistance

As for the bleeding of the image which may occur under a high-humidity condition, a 3 cm×3 cm print pattern that included 1 mm×1 mm magenta squares arranged such that a 0.5-mm blank gap was interposed between each pair of the adjacent squares was formed. This image sample was stored for 7 days at 45° C. and a relative humidity of 80%. Subsequently, the bleeding of the dye which occurred in the blank gaps was inspected.

Specifically, the OD value of the printed matter was measured with a reflection densitometer “Spectrilino” (product name, produced by Gretag) before and after the printed matter had been exposed to the above high-humidity condition (temperature: 45° C., relative humidity: 80%). An evaluation grade of “A” was given when the increase in the magenta concentration in the blanks compared with that measured immediately after the printing was less than 0.02 in a status A green filter. An evaluation grade of “B” was given when the above increase in magenta concentration was 0.02 or more and less than 0.05. An evaluation grade of “C” was given when the above increase in magenta concentration was 0.05 or more and less than 0.10. An evaluation grade of “D” was given when the above increase in magenta concentration was 0.10 or more.

TABLE 8

| | | | | Light | Ozone | Moisture |
|---|---|---|---|---|---|---|
| | | | Print | resis- | resis- | resis- |
| | Hue | Chroma | density | tance | tance | tance |
| Example 1 | A | A | A | A | A | B |
| Example 2 | A | A | A | A | A | A |
| Example 3 | A | A | A | A | A | A |
| Example 4 | A | A | A | B | B | A |
| Example 5 | A | A | A | B | B | A |
| Example 6 | B | B | A | B | B | A |
| Example 7 | B | B | A | B | B | B |
| Example 8 | A | A | A | A | A | A |
| Example 9 | A | A | A | B | A | A |
| Example 10 | B | B | A | B | B | B |
| Example 11 | A | A | A | A | A | A |
| Example 12 | A | A | A | A | A | A |
| Example 13 | A | A | A | A | A | A |
| Example 14 | A | A | A | A | A | A |
| Example 15 | A | A | A | A | A | B |
| Example 16 | A | A | A | A | A | A |
| Example 17 | A | A | A | A | A | A |
| Example 18 | A | A | A | A | A | B |
| Example 19 | A | A | A | A | A | A |
| Example 20 | A | A | A | A | A | A |
| Example 21 | A | A | A | A | A | B |
| Example 22 | A | A | A | A | A | A |
| Example 23 | A | A | A | A | A | B |
| Example 24 | A | A | A | A | A | A |
| Example 25 | A | A | A | A | A | A |
| Example 26 | A | A | A | A | A | A |
| Example 27 | A | A | A | A | A | A |
| Example 28 | A | A | A | A | A | A |
| Example 29 | A | A | A | A | A | A |
| Example 30 | B | B | A | B | B | A |
| Example 31 | B | B | A | B | B | A |
| Example 32 | B | B | A | B | B | B |
| Example 33 | B | B | A | B | B | A |
| Example 34 | B | B | A | B | B | A |

TABLE 9

| | | | | Light | Ozone | Moisture |
|---|---|---|---|---|---|---|
| | | | Print | resis- | resis- | resis- |
| | Hue | Chroma | density | tance | tance | tance |
| Comparative | B | B | A | C | C | C |
| example 1 | | | | | | |
| Comparative | A | A | A | C | C | B |
| example 2 | | | | | | |
| Comparative | A | A | C | B | B | B |
| example 3 | | | | | | |
| Comparative | B | B | A | C | C | C |
| example 4 | | | | | | |
| Comparative | B | B | A | C | C | C |
| example 5 | | | | | | |
| Comparative | B | B | A | C | C | C |
| example 6 | | | | | | |
| Comparative | A | A | A | C | C | C |
| example 7 | | | | | | |
| Comparative | A | A | A | C | C | B |
| example 8 | | | | | | |
| Comparative | C | B | D | C | C | B |
| example 9 | | | | | | |
| Comparative | B | C | B | A | B | C |
| example 10 | | | | | | |
| Comparative | A | A | A | C | C | C |
| example 11 | | | | | | |
| Comparative | A | A | A | A | A | B |
| example 12 | | | | | | |
| Comparative | B | B | B | C | C | B |
| example 13 | | | | | | |
| Comparative | A | A | C | B | B | A |
| example 14 | | | | | | |
| Comparative | A | A | C | B | B | A |
| example 15 | | | | | | |
| Comparative | B | B | A | C | C | B |
| example 16 | | | | | | |
| Comparative | B | B | A | C | C | B |
| example 17 | | | | | | |
| Comparative | A | A | A | A | A | B |
| example 18 | | | | | | |

Ejection Stability

As for the inks 1 to 27 for ink Jet recording prepared in Examples 1 to 27 and the comparative inks R1 to R12 for ink jet recording prepared in Comparative Examples 1 to 12, each of the inks for ink jet recording was charged into an ink cartridge, which was attached to an ink jet printer (“PM-700C” produced by Seiko Epson Corporation). After it had been confirmed that the ink could be ejected from all the nozzles, printing was performed to 100 A4-size paper sheets (photo paper sheets (photo paper <glossy> produced by Seiko Epson Corporation)). An evaluation was made in accordance with the following criteria.

As for the inks 28 to 34 for ink jet recording prepared in Examples 28 to 34 and the comparative inks R13 to R18 for ink jet recording prepared in Comparative Examples 13 to 18, each of the inks for ink jet recording was charged into an ink cartridge, which was attached to an ink jet printer (“PIXUS Pro9000MkII” produced by CANON INC.). After it had been confirmed that the ink could be ejected from all the nozzles, printing was performed to 100 A4-size paper sheets (ink jet paper sheets: glossy photo paper “PT-201” produced by CANON INC.). An evaluation was made in accordance with the following criteria.

A: Print disorder did not occur from the beginning to the end of printing

B: The number of printouts in which print disorder occurred was 1 or more and less than 3

C: The number of printouts in which print disorder occurred was 3 or more and less than 10

D: The number of printouts in which print disorder occurred was 10 or more and less than 15

E: The number of printouts in which print disorder occurred was 15 or more

The above ejection stability test was conducted immediately after the ink for ink jet recording had been prepared, after the ink had been stored for 4 weeks in the ink cartridge at 40° C. and a relative humidity of 80%, and after the ink had been stored for 10 weeks in the ink cartridge at 40° C. and a relative humidity of 80%.

In Tables 10 and 11 below, the results obtained when the ink for ink jet recording was used immediately after the preparation of the ink were described in the column “Immediately after ink preparation”, and the results of the test conducted after the ink had been stored for 4 or 10 weeks in the ink cartridge at 40° C. and a relative humidity of 80% were described in the column “After four-week forced test” or “After ten-week forced test”.

Long-Term Storage Stability

Each of the inks for ink jet recording was evaluated in terms of the storage stability of the ink after the ink had been stored at 60° C. for 4 weeks and after the ink had been stored at 60° C. for 10 weeks as a forced test.

The evaluation was made on the three-point scale below.

A: The ink for ink jet recording had properties that were comparable to those measured immediately after the ink had been prepared.

B: One of the properties of the ink which are the evaluation items (print density and ejection stability) became degraded after the forced test, compared with the properties measured immediately after the ink had been prepared.

C: Both of the two properties became degraded.

Tables 10 and 11 below list the results of Examples and Comparative Examples.

TABLE 10

| | Ejection stability | | | | |
|---|---|---|---|---|---|
| | Immediately | | | Long-term storage stability | |
| | after ink | After four-week | After ten-week | After four-week | After ten-week |
| | preparation | forced test | forced test | forced test | forced test |
| Example 1 | A | A | A | A | A |
| Example 2 | A | A | A | A | A |
| Example 3 | A | A | A | A | A |
| Example 4 | A | A | A | A | A |
| Example 5 | A | A | A | A | A |
| Example 6 | A | A | A | A | A |
| Example 7 | A | A | B | A | B |
| Example 8 | A | A | A | A | A |
| Example 9 | A | A | A | A | A |
| Example 10 | A | A | B | A | B |
| Example 11 | A | A | A | A | A |
| Example 12 | A | A | A | A | A |
| Example 13 | A | A | A | A | A |
| Example 14 | A | A | A | A | A |
| Example 15 | A | A | A | A | A |
| Example 16 | A | A | A | A | A |
| Example 17 | A | A | A | A | A |
| Example 18 | A | A | A | A | A |
| Example 19 | A | A | A | A | A |
| Example 20 | A | A | A | A | A |
| Example 21 | A | A | A | A | A |
| Example 22 | A | A | A | A | A |
| Example 23 | A | A | A | A | A |
| Example 24 | A | A | A | A | A |
| Example 25 | A | A | A | A | A |
| Example 26 | A | A | A | A | A |
| Example 27 | A | A | A | A | A |
| Example 28 | A | A | A | A | A |
| Example 29 | A | A | A | A | A |
| Example 30 | A | A | A | A | A |
| Example 31 | A | A | A | A | A |
| Example 32 | A | A | B | A | B |
| Example 33 | A | A | A | A | A |
| Example 34 | A | A | A | A | A |

TABLE 11

| | Ejection stability | | | | |
|---|---|---|---|---|---|
| | Immediately | | | Long-term storage stability | |
| | after ink | After four-week | After ten-week | After four-week | After ten-week |
| | preparation | forced test | forced test | forced test | forced test |
| Comparative | A | B | B | B | B |
| example 1 | | | | | |
| Comparative | A | B | B | B | B |
| example 2 | | | | | |
| Comparative | A | A | A | A | A |
| example 3 | | | | | |
| Comparative | A | B | B | B | B |
| example 4 | | | | | |
| Comparative | A | B | B | B | B |
| example 5 | | | | | |
| Comparative | A | B | B | B | B |
| example 6 | | | | | |
| Comparative | A | B | B | B | B |
| example 7 | | | | | |
| Comparative | A | B | B | B | B |
| example 8 | | | | | |
| Comparative | A | B | B | B | B |
| example 9 | | | | | |
| Comparative | A | B | B | B | B |
| example 10 | | | | | |
| Comparative | A | B | C | B | C |
| example 11 | | | | | |
| Comparative | A | B | C | B | C |
| example 12 | | | | | |
| Comparative | A | B | B | B | B |
| example 13 | | | | | |
| Comparative | A | A | A | A | A |
| example 14 | | | | | |
| Comparative | A | A | A | A | A |
| example 15 | | | | | |
| Comparative | A | B | B | B | B |
| example 16 | | | | | |
| Comparative | A | B | B | B | B |
| example 17 | | | | | |
| Comparative | A | B | C | B | C |
| example 18 | | | | | |

As is clear from the results described in Tables 8 to 11, it was confirmed that the inks for ink jet recording prepared in Examples enabled the formation of an image that had a magenta hue, a high chroma, and a high print density and that was excellent in terms of light resistance, ozone resistance, and moisture resistance. It was also confirmed that the inks for ink jet recording were also excellent in terms of long-term storage stability.

According to the present invention, a coloring composition that enables the formation of an image that has a magenta hue, a high chroma, and a high print density and that is excellent in terms of light resistance, ozone resistance, and moisture resistance, the coloring composition being also excellent in terms of long-term storage stability, an ink for ink jet recording which includes the coloring composition, an ink jet recording method in which the ink for ink jet recording is used, and an ink jet printer cartridge including the ink for ink jet recording may be provided.

While details of the present invention are described with reference to specific embodiments, it is apparent to those skilled in the art that various modifications can be made without departing from the spirit and the scope of the present invention.

What is claimed is:

1. A coloring composition comprising:
a compound represented by the following General Formula (1); and
a compound represented by the following General Formula (D),
wherein a mass ratio {General Formula (1)/General Formula (D)} of a content of the compound represented by the General Formula (1) to a content of the compound represented by the General Formula (D) is {99/1} to {50/50}, 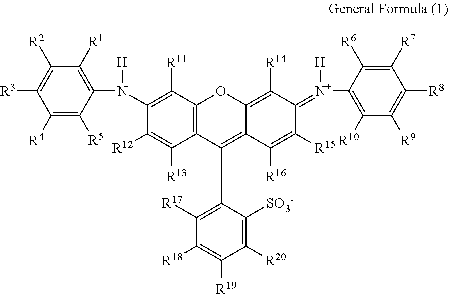
wherein, in the General Formula (1), R¹, R⁵, R⁶, and R¹⁰ each independently represent an alkyl group; R⁴, R⁹, R¹¹, R¹², R¹³, R¹⁴, R¹⁵, R¹⁶, R¹⁷, R¹⁸, R¹⁹, and R²⁰ each independently represent a hydrogen atom, an alkyl group, an aryl group, a halogen atom, a carboxyl group, or a sulfo group; R², R³, R⁷, and R⁸ each independently represent a hydrogen atom, an alkyl group, or a substituent represented by the following General Formula (A); and at least one of R², R³, R⁷, or R⁸ represents a substituent represented by the General Formula (A), 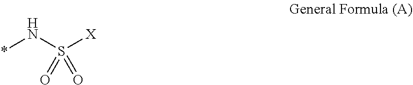
wherein, in the General Formula (A), X represents a substituent represented by the following General Formula (X1), (X2), or (X3); and * denotes a direct bond to a benzene ring, 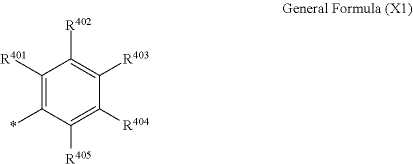
wherein, in the General Formula (X1), R⁴⁰¹, R⁴⁰², R⁴⁰³, R⁴⁰⁴, and R⁴⁰⁵ each independently represent a hydrogen atom, an alkyl group, an aryl group, a hydroxyl group, a halogen atom, a nitro group, a trifluoromethyl group, a carboxyl group, or a sulfo group; R⁴⁰¹, R⁴⁰², R⁴⁰³, R⁴⁰⁴, and R⁴⁰⁵ satisfy the following condition (i) or (ii); and * denotes a direct bond to a sulfur atom,
Condition (i): At least one of R⁴⁰¹, R⁴⁰², R⁴⁰³, R⁴⁰⁴, or R⁴⁰⁵ represents a hydroxyl group, and at least one of R⁴⁰¹, R⁴⁰², R⁴⁰³, R⁴⁰⁴, or R⁴⁰⁵ represents a carboxyl group,
Condition (ii): At least two of R⁴⁰¹, R⁴⁰², R⁴⁰³, R⁴⁰⁴, and R⁴⁰⁵ represent a carboxyl group, 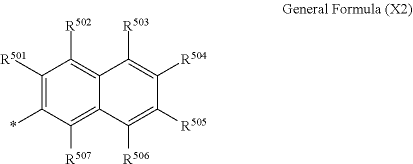
wherein, in the General Formula (X2), R⁵⁰¹, R⁵⁰², R⁵⁰³, R⁵⁰⁴, R⁵⁰⁵, R⁵⁰⁶, and R⁵⁰⁷ each independently represent a hydrogen atom, an alkyl group, an aryl group, a hydroxyl group, a halogen atom, a nitro group, a trifluoromethyl group, a carboxyl group, or a sulfo group; R⁵⁰¹, R⁵⁰², R⁵⁰³, R⁵⁰⁴, R⁵⁰⁵, R⁵⁰⁶, and R⁵⁰⁷ satisfy the following condition (iii) or (iv); and * denotes a direct bond to a sulfur atom,
Condition (iii): At least one of R⁵⁰¹, R⁵⁰², R⁵⁰³, R⁵⁰⁴, R⁵⁰⁵, R⁵⁰⁶, or R⁵⁰⁷ represents a hydroxyl group, and at least one of R⁵⁰¹, R⁵⁰², R⁵⁰³, R⁵⁰⁴, R⁵⁰⁵, R⁵⁰⁶, or R⁵⁰⁷ represents a carboxyl group,
Condition (iv): At least two of R⁵⁰¹, R⁵⁰², R⁵⁰³, R⁵⁰⁴, R⁵⁰⁵, R⁵⁰⁶, and R⁵⁰⁷ represent a carboxyl group, 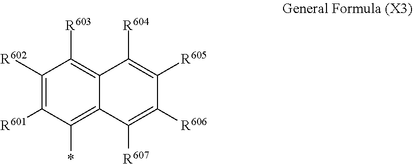
wherein, in the General Formula (X3), R⁶⁰¹, R⁶⁰², R⁶⁰³, R⁶⁰⁴, R⁶⁰⁵, R⁶⁰⁶, and R⁶⁰⁷ each independently represent a hydrogen atom, an alkyl group, an aryl group, a hydroxyl group, a halogen atom, a nitro group, a trifluoromethyl group, a carboxyl group, or a sulfo group; R⁶⁰¹, R⁶⁰², R⁶⁰³, R⁶⁰⁴, R⁶⁰⁵, R⁶⁰⁶, and R⁶⁰⁷ satisfy the following condition (v) or (vi); and * denotes a direct bond to a sulfur atom,
Condition (v): At least one of R⁶⁰¹, R⁶⁰², R⁶⁰³, R⁶⁰⁴, R⁶⁰⁵, R⁶⁰⁶, or R⁶⁰⁷ represents a hydroxyl group, and at least one of R⁶⁰¹, R⁶⁰², R⁶⁰³, R⁶⁰⁴, R⁶⁰⁵, R⁶⁰⁶, or R⁶⁰⁷ represents a carboxyl group,
Condition (vi): At least two of R⁶⁰¹, R⁶⁰², R⁶⁰³, R⁶⁰⁴, R⁶⁰⁵, R⁶⁰⁶, and R⁶⁰⁷ represent a carboxyl group, and 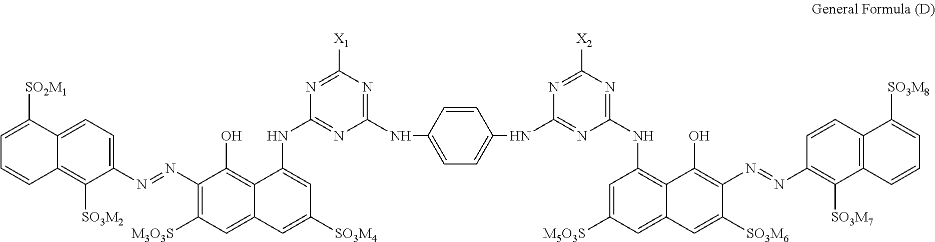
wherein, in the General Formula (D), X₁ and X₂ each independently represent a chlorine atom, a hydroxyl group, or an amino group; and M₁ to M₈ each independently represent a hydrogen atom, an ammonium ion, an alkali metal ion, or an organic cation.

2. The coloring composition according to claim 1,
wherein the X of the General Formula (A) represents a substituent represented by the General Formula (X1) and the R⁴⁰¹, R⁴⁰², R⁴⁰³, R⁴⁰⁴, and R⁴⁰⁵ of the General Formula (X1) satisfy the condition (i).

3. The coloring composition according to claim 1,
wherein the X of the General Formula (A) represents a substituent represented by the General Formula (X2) and the R⁵⁰¹, R⁵⁰², R⁵⁰³, R⁵⁰⁴, R⁵⁰⁵, R⁵⁰⁶, and R⁵⁰⁷ of the General Formula (X2) satisfy the condition (iii).

4. The coloring composition according to claim 1,
wherein the X of the General Formula (A) represents a substituent represented by the General Formula (X3) and the R⁶⁰¹, R⁶⁰², R⁶⁰³, R⁶⁰⁴, R⁶⁰⁵, R⁶⁰⁶, and R⁶⁰⁷ of the General Formula (X3) satisfy the condition (v).

5. The coloring composition according to claim 1,
wherein a total content of the compound represented by the General Formula (1) and the compound represented by the General Formula (D) in the coloring composition is 3.5% by mass or less.

6. The coloring composition according to claim 2,
wherein a total content of the compound represented by the General Formula (1) and the compound represented by the General Formula (D) in the coloring composition is 3.5% by mass or less.

7. The coloring composition according to claim 3,
wherein a total content of the compound represented by the General Formula (1) and the compound represented by the General Formula (D) in the coloring composition is 3.5% by mass or less.

8. The coloring composition according to claim 4,
wherein a total content of the compound represented by the General Formula (1) and the compound represented by the General Formula (D) in the coloring composition is 3.5% by mass or less.

9. The coloring composition according to claim 1,
wherein the mass ratio {General Formula (1)/General Formula (D)} of the content of the compound represented by the General Formula (1) to the content of the compound represented by the General Formula (D) is {99/1} to {60/40}.

10. The coloring composition according to claim 2,
wherein the mass ratio {General Formula (1)/General Formula (D)} of the content of the compound represented by the General Formula (1) to the content of the compound represented by the General Formula (D) is {99/1} to {60/40}.

11. The coloring composition according to claim 3,
wherein the mass ratio {General Formula (1)/General Formula (D)} of the content of the compound represented by the General Formula (1) to the content of the compound represented by the General Formula (D) is {99/1} to {60/40}.

12. The coloring composition according to claim 4,
wherein the mass ratio {General Formula (1)/General Formula (D)} of the content of the compound represented by the General Formula (1) to the content of the compound represented by the General Formula (D) is 199/11 to 160/401.

13. The coloring composition according to claim 5,
wherein the mass ratio {General Formula (1)/General Formula (D)} of the content of the compound represented by the General Formula (1) to the content of the compound represented by the General Formula (D) is {99/1} to {60/40}.

14. The coloring composition according to claim 6,
wherein the mass ratio {General Formula (1)/General Formula (D)} of the content of the compound represented by the General Formula (1) to the content of the compound represented by the General Formula (D) is {99/1} to {60/40}.

15. The coloring composition according to claim 7,
wherein the mass ratio {General Formula (1)/General Formula (D)} of the content of the compound represented by the General Formula (1) to the content of the compound represented by the General Formula (D) is {99/1} to {60/40}.

16. The coloring composition according to claim 8,
wherein the mass ratio {General Formula (1)/General Formula (D)} of the content of the compound represented by the General Formula (1) to the content of the compound represented by the General Formula (D) is {99/1} to {60/40}.

17. An ink for ink jet recording comprising the coloring composition according to claim 1.

18. An ink jet recording method using the ink for ink jet recording according to claim 17.

19. An ink jet printer cartridge comprising:
the ink for ink jet recording according to claim 17.
